(19) United States
(12) Patent Application Publication
(10) Pub. No.: US 2026/0255431 A1
(43) Pub. Date: Aug. 27, 2026

(54) METHOD AND DEVICE FOR ACCESSING NETWORK ENERGY SAVING (NES) CELL SUPPORTING CELL DISCONTINUOUS TRANSMISSION (DTX)/DISCONTINUOUS RECEPTION (DRX) IN MOBILE COMMUNICATION SYSTEM

(71) Applicant: Samsung Electronics Co., Ltd., Gyeonggi-do (KR)

(72) Inventors: Sangyeob JUNG, Gyeonggi-do (KR); Anil AGIWAL, Gyeonggi-do (KR); Byounghoon JUNG, Gyeonggi-do (KR)

(21) Appl. No.: 19/155,787

(22) PCT Filed: Feb. 13, 2024
(86) PCT No.: PCT/KR2024/002013

§ 371 Date: Aug. 12, 2025

(30) Foreign Application Priority Data
Feb. 13, 2023 (KR) 10-2023-0018693

(51) Int. Cl. H04W 76/27; H04W 74/0833; H04W 76/28

(52) U.S. Cl. CPC H04W 76/27; H04W 74/0833; H04W 76/28

(57) ABSTRACT

The present disclosure relates to a 5G or 6G communication system for supporting a higher data transfer rate. The present disclosure relates to operations of a user equipment and a base station in a mobile communication system and, particularly, to a method and a device for accessing a network energy saving (NES) cell supporting cell discontinuous transmission (DTX)/discontinuous reception (DRX) in a mobile communication system.

### TECHNICAL FIELD

The disclosure relates to an operation of a terminal and a base station in a mobile communication system and, particularly, to a method and a device for accessing a network energy saving (NES) cell supporting cell discontinuous transmission (DTX)/discontinuous reception (DRX).

### BACKGROUND ART

5G mobile communication technologies define broad frequency bands to enable high transmission rates and new services, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (e.g., 95 GHz to 3THz bands) in order to accomplish transmission rates fifty times faster than 5G mobile communication technologies and ultra-low latencies one-tenth of 5G mobile communication technologies.

At the beginning of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks. AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided, and accordingly there is a need for ways to effectively provide these services.

### DISCLOSURE

### Technical Problem

Various embodiments of the disclosure are to provide a device and a method capable of effectively providing services in a mobile communication system.

### Solution to Problem

A method of a terminal in a wireless communication system according to an embodiment of the disclosure may include entering an RRC idle state or an RRC inactive state, camping on a cell, receiving system information for cell reselection from the cell, and performing cell reselection in a cell non-active period of the cell.

A terminal of a wireless communication system according to another embodiment of the disclosure may include a transceiver, and a controller connected to the transceiver, wherein the controller is configured to enter an RRC idle state or an RRC inactive state, camp on a cell, receive system information for cell reselection from the cell, and perform cell reselection in a cell non-active period of the cell.

### Advantageous Effects of Invention

Various embodiments of the disclosure can provide a device and a method capable of effectively providing services in a mobile communication system.

### BRIEF DESCRIPTION OF DRAWINGS

FIG. 1A illustrates a structure of an LTE system according to an embodiment of the disclosure.

FIG. 1B illustrates a radio protocol structure in an LTE system according to an embodiment of the disclosure.

FIG. 1C illustrates a structure of a next-generation mobile communication system according to an embodiment of the disclosure.

FIG. 1D illustrates a radio protocol structure of a next-generation mobile communication system according to an embodiment of the disclosure.

FIG. 1E is a diagram illustrating a cell reselection procedure performed by a terminal in a next-generation mobile communication system according to an embodiment of the disclosure.

FIG. 1F is a diagram illustrating a concept of cell discontinuous transmission (DTX)/cell discontinuous reception (DRX) according to an embodiment of the disclosure.

FIG. 1G is a diagram illustrating a method of, when a NES cell that is a current serving cell is in a cell DTX/DRX non-active period, accessing a cell by a NES terminal according to an embodiment of the disclosure.

FIG. 1H is a diagram illustrating a method of, when a NES cell that is a current serving cell is in a cell DTX/DRX non-active period, accessing a cell by a NES terminal according to an embodiment of the disclosure.

FIG. 1I is a diagram illustrating a method of, when a NES cell that is a current serving cell is in a cell DTX/DRX non-active period, accessing a cell by a NES terminal according to an embodiment of the disclosure.

FIG. 1J is a diagram illustrating a method of, when a NES cell that is a current serving cell is in a cell DTX/DRX non-active period, accessing a cell by a NES terminal according to an embodiment of the disclosure.

FIG. 1K is a diagram illustrating a method of, when a NES cell that is a current serving cell is in a cell DTX/DRX non-active period, accessing a cell by a NES terminal according to an embodiment of the disclosure.

FIG. 1L is a diagram illustrating a procedure in which a base station releases a connection of a terminal and thus the terminal switches from an RRC connected mode to an RRC idle mode and a procedure in which the terminal configures a connection with the base station and thus switches from the RRC idle mode to the RRC connected mode according to an embodiment of the disclosure.

FIG. 1M is a diagram illustrating a procedure in which a base station releases a connection of a terminal and thus the terminal switches from an RRC connected mode to an RRC inactive mode and a procedure in which the terminal configures a connection with the base station and thus switches from the RRC inactive mode to the RRC connected mode according to an embodiment of the disclosure.

FIG. 1N is a block diagram illustrating an internal structure of a UE according to an embodiment of the disclosure.

FIG. 1O is a block diagram illustrating a structure of an NR base station according to an embodiment of the disclosure.

### BEST MODE FOR CARRYING OUT THE INVENTION

A method of a terminal in a wireless communication system according to an embodiment of the disclosure may include entering an RRC idle state or an RRC inactive state, camping on a cell, receiving system information for cell reselection from the cell, and performing cell reselection in a cell non-active period of the cell.

In an embodiment, the performing of cell reselection in the cell non-active period of the cell may include, in case that it is determined that there is a suitable cell, based on the system information, performing cell reselection for the suitable cell, and in case that it is determined that there is no suitable cell, based on the system information, performing cell reselection in a cell active period after termination of the cell non-active period.

In an embodiment, the system information may include information related to cell reselection of the terminal, the information related to the cell reselection of the terminal may include a frequency-specific cell list including frequency- or cell-specific random access resource information or frequency-specific random access resource information, and the performing of cell reselection in the cell non-active period of the cell may include performing cell reselection, based on the information related to the cell reselection.

In an embodiment, the system information may include a threshold value related to the cell non-active period, and the performing of cell reselection in the cell non-active period of the cell may include in case that a remaining time of the cell non-active period is equal to or smaller than the threshold value, performing cell reselection in a cell active period after termination of the cell non-active period, and in case that the remaining time of the cell non-active period is greater than the threshold value, immediately performing the cell reselection.

In an embodiment, the performing of cell reselection in the cell non-active period of the cell may include transmitting a wake-up signal to the cell, and in case that the cell transitions to a cell active period due to the wake-up signal, performing the cell reselection for the cell.

In an embodiment, the system information may include at least one of frequency information and time information related to the wake-up signal, and an indicator indicating whether at least one of a low-power receiver and a wake-up signal receiver is supported.

In an embodiment, the performing of cell reselection in the cell non-active period of the cell may include, in case that it is determined that there is a suitable cell, based on a frequency and a cell related to cell reselection, performing cell reselection for the suitable cell, and in case that it is determined that there is no suitable cell, performing cell reselection in the cell active period after termination of the cell non-active period.

In an embodiment, the system information may include at least one of an indicator indicating whether at least one of cell DTX and cell DRX is supported, and cell DTX pattern information and cell DRX pattern information.

In an embodiment, a terminal of a wireless communication system according to another embodiment of the disclosure may include a transceiver, and a controller connected to the transceiver, wherein the controller is configured to enter an RRC idle state or an RRC inactive state, camp on a cell, receive system information for cell reselection from the cell, and perform cell reselection in a cell non-active period of the cell.

In an embodiment, the controller may be configured to, in case that it is determined that there is a suitable cell, based on the system information, perform cell reselection for the suitable cell, and in case that it is determined that there is no suitable cell, based on the system information, perform cell reselection in a cell active period after termination of the cell non-active period.

In an embodiment, the system information may include information related to cell reselection of the terminal, the information related to the cell reselection of the terminal may include a frequency-specific cell list including frequency- or cell-specific random access resource information or frequency-specific random access resource information, and the controller may be configured to perform cell reselection, based on the information related to the cell reselection.

In an embodiment, the system information may include a threshold value related to the cell non-active period, and the controller may be configured to in case that a remaining time of the cell non-active period is equal to or smaller than the threshold value, perform cell reselection in a cell active period after termination of the cell non-active period, and in case that the remaining time of the cell non-active period is greater than the threshold value, immediately perform the cell reselection.

In an embodiment, the controller may be configured to transmit a wake-up signal to the cell, and in case that the cell transitions to a cell active period due to the wake-up signal, perform the cell reselection for the cell.

In an embodiment, the system information may include at least one of frequency information and time information related to the wake-up signal, and an indicator indicating whether at least one of a low-power receiver and a wake-up signal receiver is supported.

In an embodiment, the controller may be configured to, in case that it is determined that there is a suitable cell, based on a frequency and a cell related to cell reselection, perform cell reselection for the suitable cell, and in case that it is determined that there is no suitable cell, perform cell reselection in a cell active period after termination of the cell non-active period.

### MODE FOR THE INVENTION

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art ofthe scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

In describing the disclosure below, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. Of course, the base station and the terminal are not limited to the above examples. In the disclosure, a “downlink (DL)” refers to a radio link via which a base station transmits a signal to a terminal, and an “uplink (UL)” refers to a radio link via which a terminal transmits a signal to a base station.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

According to some embodiments, eMBB may aim at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique may be required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system, mMTC may have requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and may also require a packet error rate of 10⁻⁵ or less. However, mMTC, URLLC, and eMBB as described above are merely an example of different types of services, and service types to which the disclosure is applied are not limited to those mentioned above.

The above-described three services considered in the 5G communication system, that is, eMBB, URLLC, and mMTC, may be multiplexed and transmitted in a single system. In this case, different transmission/reception techniques and transmission/reception parameters may be used between services in order to satisfy different requirements of the respective services. However, mMTC, URLLC, and eMBB as described above are merely an example of different types of services, and service types to which the disclosure is applied are not limited to those mentioned above.

In addition, based on determinations by those skilled in the art, the disclosure may be applied to other communication systems through some modifications without significantly departing from the scope of the disclosure. Herein, it will be understood that each block of the flowchart illustrations, and combinations of blocks in the flowchart illustrations, can be implemented by computer program instructions.

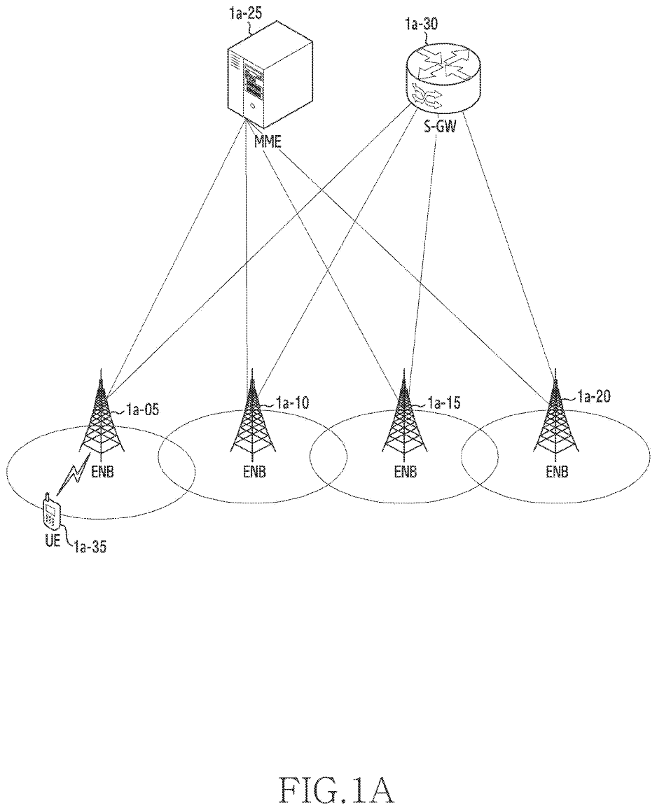

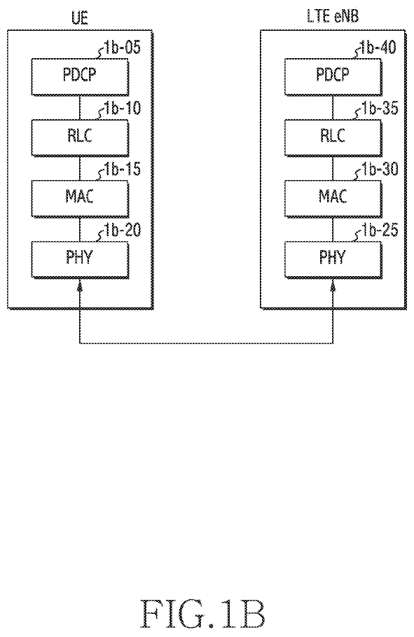

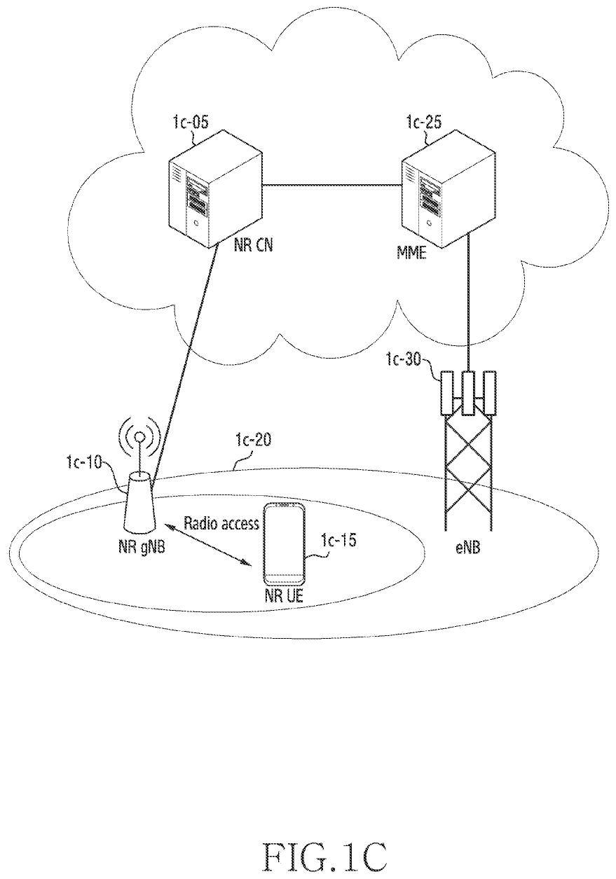

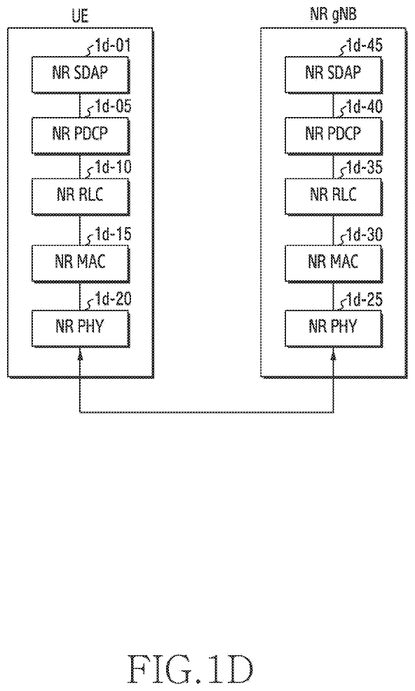

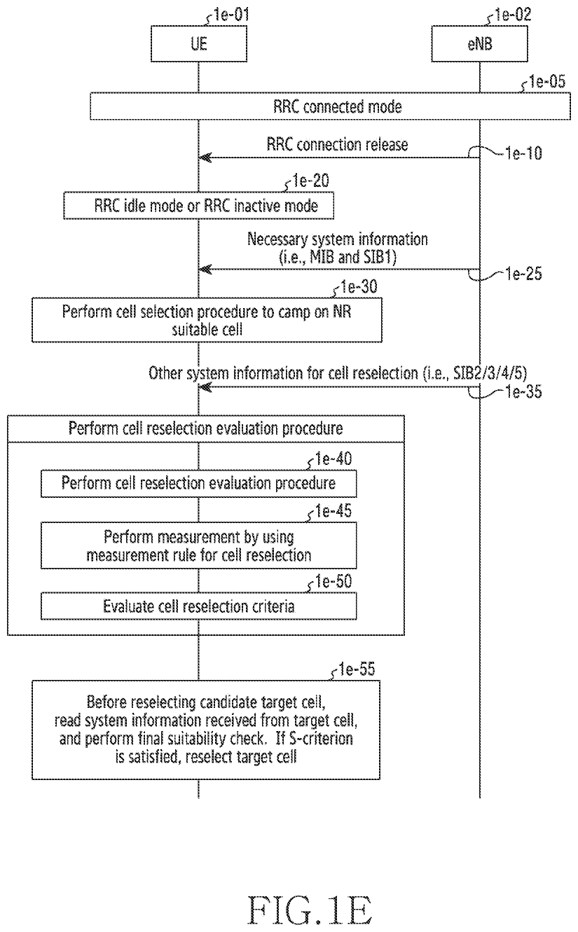

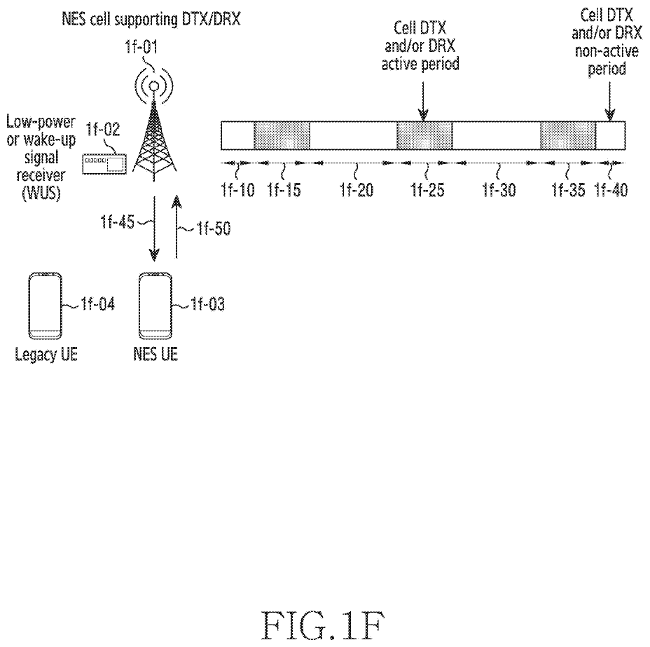

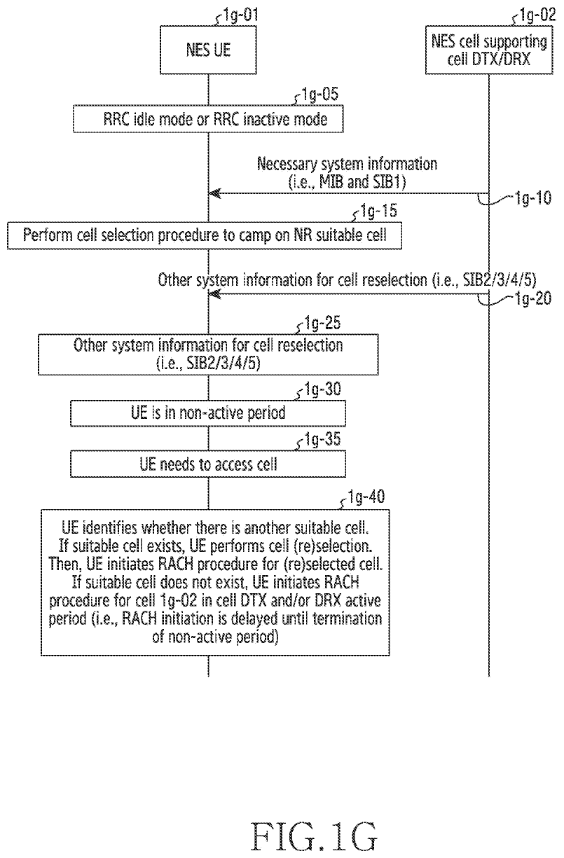

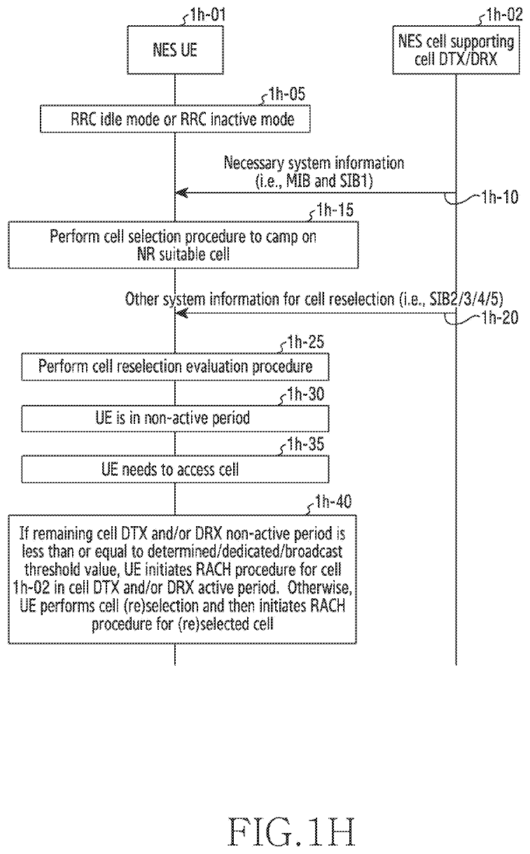

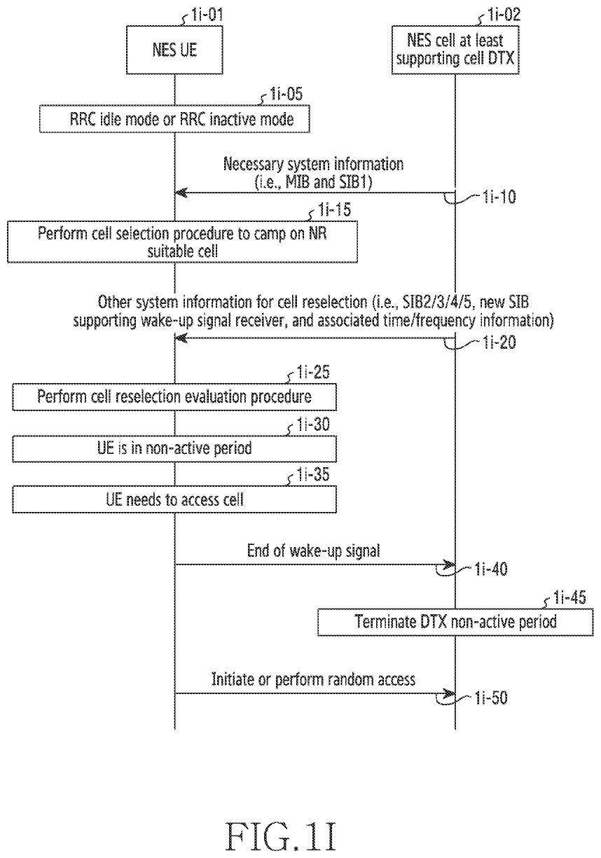

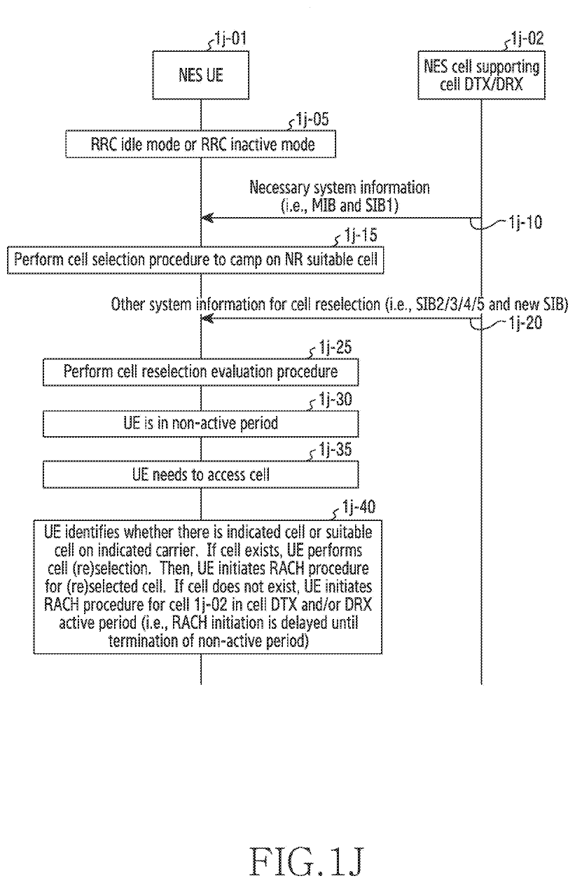

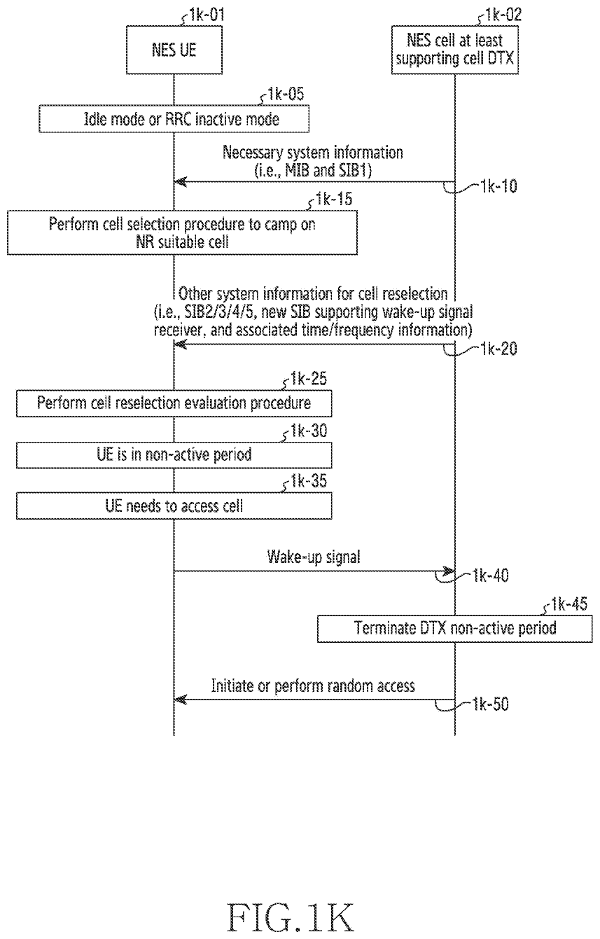

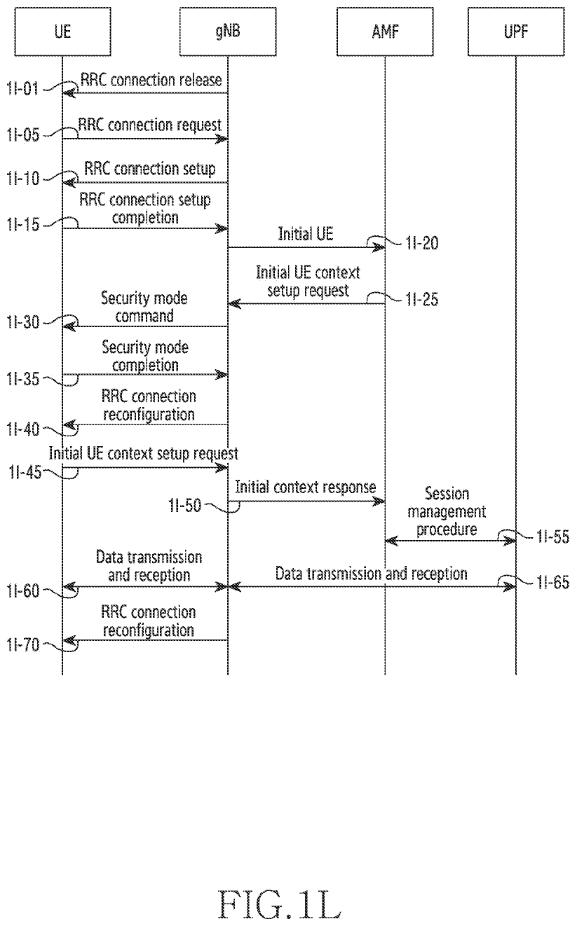

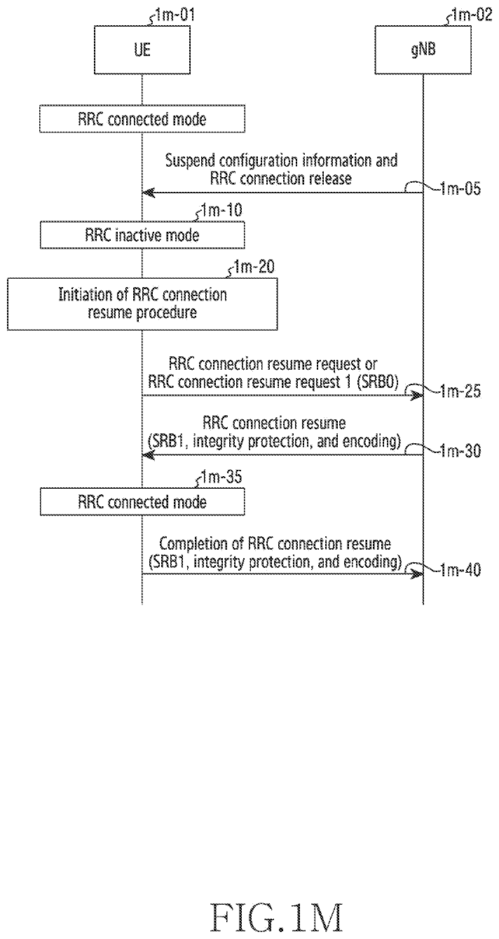

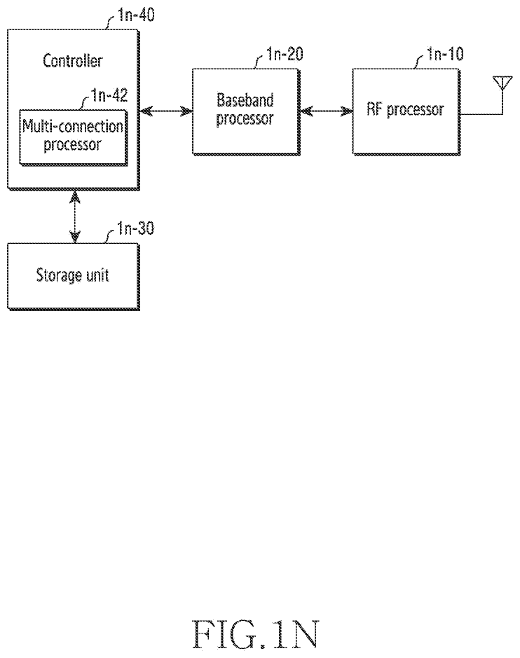

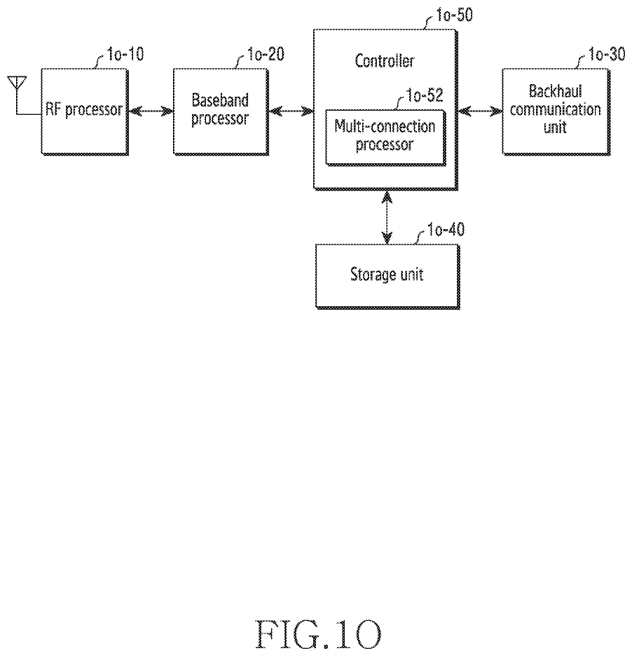

In the following description, terms and names defined in the 3rd generation partnership project long term evolution (3GPP LTE) standards will be used for the sake of descriptive convenience. However, the disclosure is not limited by these terms and names, and may be applied in the same way to systems that conform other standards. In the disclosure, the term “eNB” may be interchangeably used with the term “gNB” for the sake of descriptive convenience. That is, a base station described as “eNB” may refer to “gNB”. 1611 FIG. 1A illustrates a structure of an LTE system according to an embodiment of the disclosure.

Referring to FIG. 1A, as illustrated therein, a radio access network of an LTE system may include next-generation base stations (evolved node Bs, hereinafter ENBs, node Bs, or base stations) 1a-05, 1a-10, 1a-15, and 1a-20, a mobility management entity (MME) 1a-25, and a serving gateway (S-GW) 1a-30. A user equipment (hereinafter UE or terminal) 1a-35 may access an external network through the ENBs 1a-05 to 1a-20 and the S-GW 1a-30.

In FIG. 1A, the ENBs 1a-05 to 1a-20 may correspond to conventional node Bs of a universal mobile telecommunication system (UMTS). The ENBs may be connected to the UE 1a-35 through a radio channel, and perform more complicated roles than the conventional node Bs. In the LTE system, since all user traffic including real-time services, such as voice over IP (VoIP) via the Internet protocol, may be serviced through a shared channel. Thus, a device that collects state information, such as buffer states, available transmit power states, and channel states of UEs, and performs scheduling accordingly is required, and the ENBs 1a-05 to 1a-20 may serve as the device. In general, one ENB may control multiple cells. For example, in order to implement a transfer rate of 100 Mbps, the LTE system may use orthogonal frequency division multiplexing (OFDM) as a radio access technology in a bandwidth of, for example, 20 MHz. Furthermore, the LTE system may employ an adaptive modulation & coding (AMC) scheme for determining a modulation scheme and a channel coding rate according to a channel state of a UE. The S-GW 1a-30 is a device that provides a data bearer, and may generate or remove a data bearer under the control of the MME 1a-25. The MME is a device responsible for various control functions as well as a mobility management function for a UE, and may be connected to multiple base stations.

FIG. 1B illustrates a radio protocol structure in an LTE system according to an embodiment of the disclosure.

Referring to FIG. 1B, a radio protocol of an LTE system may include a packet data convergence protocol (PDCP) 1b-05 or 1b-40, a radio link control (RLC) 1b-10 or 1b-35, and a medium access control (MAC) 1b-15 or 1b-30 on each of UE and ENB sides. The PDCP may serve to perform operations such as IP header compression/reconstruction. The main functions of the PDCP may be summarized as follows. The PDCP is not limited by the following exemplary functions and may perform various functions.
Header compression and decompression: robust header compression (ROHC) only
Transfer of user data
In-sequence delivery (In-sequence delivery of upper layer PDUs at PDCP re-establishment procedure for RLC AM)
For split bearers in dual connectivity (DC) (only support for RLC AM): PDCP PDU routing for transmission and PDCP PDU reordering for reception
Duplicate detection of lower layer SDUs at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink

The radio link control (RLC) 1b-10 or 1b-35 may reconfigure a PDCP protocol data unit (PDU) into appropriate sizes to perform an automatic repeat request (ARQ) operation. The main functions of the RLC may be summarized as follows. The RLC is not limited by the following exemplary functions and may perform various functions.
Transfer of upper layer PDUs
Error Correction through ARQ (only for AM data transfer)
Concatenation, segmentation and reassembly of RLC SDUs (only for UM and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

The MAC 1b-15 or 1b-30 is connected to several RLC layer devices configured in a single UE, and multiplexes RLC PDUs into a MAC PDU and demultiplexes a MAC PDU into RLC PDUs. The main functions of the MAC are summarized as follows. The MAC is not limited by the following exemplary functions and may perform various functions.
Mapping between logical channels and transport channels
Multiplexing/demultiplexing of MAC SDUs belonging to one or different logical channels into/from transport blocks (TB) delivered to/from the physical layer on transport channels
Scheduling information reporting
HARQ (Error correction through HARQ)
Priority handling between logical channels of one UE
Priority handling between UEs by means of dynamic scheduling
Multimedia broadcast and multicast service (MBMS) service identification
Transport format selection
Padding

A physical (PHY) layer 1b-20 or 1b-25 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer. The PHY layer is not limited by these exemplary functions and may perform various functions.

FIG. 1C illustrates a structure of a next-generation mobile communication system according to an embodiment of the disclosure.

Referring to FIG. 1C, a radio access network of a next-generation mobile communication system (hereinafter NR or 5G) may include a new radio node B (hereinafter NR gNB or NR base station) 1c-10, and a new radio core network (NR CN) 1c-05. Anew radio user equipment (NR UE or NR terminal) 1c-15 may access an external network via the NR gNB 1c-10 and the NR CN 1c-05.

In FIG. 1C, the NR gNB 1c-10 may correspond to an evolved node B (eNB) of a conventional LTE system. The NR gNB is connected to the NR UE 1c-15 through a radio channel, and can provide outstanding services as compared to a conventional node Bs. In the next-generation mobile communication system, since all user traffic may be serviced through a shared channel. Thus, a device that collects state information, such as buffer states, available transmit power states, and channel states of UEs, and performs scheduling accordingly is required, and the NR gNB 1c-15 may serve as the device. In general, one NR gNB may control multiple cells. In order to implement ultrahigh-speed data transfer beyond the current LTE, the next-generation mobile communication system may employ a wider bandwidth than the existing maximum bandwidth. In addition, the next-generation mobile communication system may employ an orthogonal frequency division multiplexing (OFDM) as a radio access technology, and may additionally integrate a beamforming technology therewith. Furthermore, the next-generation mobile communication system may employ an adaptive modulation & coding (hereinafter referred to as AMC) scheme for determining a modulation scheme and a channel coding rate according to a channel state of a UE. The NR CN 1c-05 may perform functions such as mobility support, bearer configuration, and QoS configuration. The NR CN is a device responsible for various control functions as well as a mobility management function for a UE, and may be connected to multiple base stations. In addition, the next-generation mobile communication system may interwork with the existing LTE system, and the NR CN may be connected to an MME 1c-25 via a network interface. The MME may be connected to an eNB 1c-30 that is an existing base station.

FIG. 1D illustrates a radio protocol structure of a next-generation mobile communication system according to an embodiment of the disclosure.

Referring to FIG. 1D, a radio protocol of a next-generation mobile communication system may include an NR service data adaptation protocol (SDAP) 1d-01 or 1d-45, an NR packet data convergence protocol (PDCP) 1d-05 or 1d-40, an NR RLC 1d-10 or 1d-35, and an NR MAC 1d-15 or 1d-30 on each of UE and NR gNB sides.

The main functions of the NR SDAP 1d-01 or 1d-45 may include some of functions below. The NR SDAP is not limited by the following exemplary functions and may perform various functions.
Transfer of user plane data
Mapping between a QoS flow and a data bearer for uplink and downlink (mapping between a QoS flow and a DRB for both DL and UL)
Marking QoS flow ID in both DL and UL packets
Reflective QoS flow to DRB mapping for the UL SDAP PDUs

With regard to the SDAP layer device, whether to use the header of the SDAP layer device or whether to use functions of the SDAP layer device may be configured for the UE through an RRC message according to PDCP layer devices or according to bearers or according to logical channels. If an SDAP header is configured, the non-access stratum (NAS) quality of service (QoS) reflection configuration 1-bit indicator (NAS reflective QoS) of the SDAP header and the access stratum (AS) QoS reflection configuration1-bit indicator (AS reflective QoS) may indicate, to the UE, that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

The main functions of the NR PDCP 1d-05 or 1d-40 may include some of functions below. The NR PDCP is not limited by the following exemplary functions and may perform various functions.
Header compression and decompression: robust header compression (ROHC) only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The reordering of the NR PDCP device may refer to a function of reordering PDCP PDUs received from a lower layer in an order based on PDCP sequence numbers (SNs). The reordering of the NR PDCP device may include a function of transferring data to an upper layer according to a rearranged order, a function of directly transferring data without considering order, a function of rearranging order to record lost PDCP PDUs, a function of reporting the state of lost PDCP PDUs to a transmission side, and a function of requesting retransmission of lost PDCP PDUs.

The main functions of the NR RLC 1d-10 or 1d-35 may include some of functions below. The NR RLC is not limited by the following exemplary functions and may perform various functions.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The In-sequence delivery of the NR RLC device may refer to a function of successively delivering RLC SDUs received from the lower layer to the upper layer. If one original RLC SDU is divided into several RLC SDUs and the RLC SDUs are received, the In-sequence delivery function of the NR RLC device may include a function of reassembling the several RLC SDUs and transferring the reassembled RLC SDUs.

The In-sequence delivery of the NR RLC device may include at least one of a function of, if one original RLC SDU is segmented into multiple RLC SDUs and the segmented RLC SDUs are received, reassembling the RLC SDUs and delivering the reassembled RLC SDUs, a function of reordering the received RLC PDUs with reference to the RLC sequence number (SN) or PDCP sequence number (SN), a function of recording RLC PDUs lost as a result of reordering, a function of reporting the state of the lost RLC PDUs to the transmitting side, and a function of requesting retransmission of the lost RLC PDUs.

The In-sequence delivery of the NR RLC device may refer to a function of, if there is a lost RLC PDU, delivering only RLC SDUs before the lost RLC PDU to the upper layer in sequence.

The In-sequence delivery of the NR RLC device may include a function of, although there is a lost RLC SDU, if a predetermined timer has expired, sequentially transferring, to a upper layer, all the RLC SDUs received before the timer is started.

The In-sequence delivery of the NR RLC device may include a function of, although there is a lost RLC SDU, if a predetermined timer has expired, sequentially transferring all the RLC SDUs received up to the current, to a upper layer.

The NR RLC device may process RLC PDUs in a reception sequence, regardless of a sequence based on sequence numbers (out-of-sequence delivery), and then deliver the processed RLC PDUs to the NR PDCP device.

If receiving segments, the NR RLC device may receive segments stored in a buffer or to be received in the future, reconfigure the segments into one whole RLC PDU, process the RLC PDU, and then deliver the processed RLC PDU to the NR PDCP device.

The NR RLC layer may not include a concatenation function, but the concatenation function may be performed in the NR MAC layer or replaced with a multiplexing function of the NR MAC layer.

The out-of-sequence delivery of the NR RLC device 1035 or 1060 may refer to a function of directly delivering RLC SDUs, received from the lower layer, to the upper layer regardless of the sequence. The out-sequence delivery of the NR RLC device may include a function of, if one original RLC SDU is segmented into multiple RLC SDUs and the segmented RLC SDUs are received, reassembling the RLC SDUs and delivering the reassembled RLC SDUs. The out-of-sequence delivery function of the NR RLC device may include a function of storing an RLC sequence number (SN) or a PDCP sequence number (SN) of received RLC PDUs and arranging order to record lost RLC PDUs.

The NR MAC 1d-15 or 1d-30 may be connected to multiple NR RLC layer devices configured in one UE, and the main functions of the NR MAC may include some of functions below. The NR MAC is not limited by the following exemplary functions and may perform various functions.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

An NR physical (PHY) layer 1d-20 or 1d-25 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer. The NR PHY layer is not limited by these exemplary functions and may perform various functions.

FIG. 1E is a diagram illustrating a cell reselection procedure performed by a UE in a next-generation mobile communication system according to an embodiment of the disclosure.

Referring to FIG. 1E, in operation 1e-05, a UE 1e-01 may configure an RRC connection with an NR base station 1e-02 to be in an RRC connected mode (RRC_CONNECTED).

In operation 1e-10, the NR base station 1e-02 may transmit an RRC connection release message (RRCRelease) to the UE 1e-01.

In operation 1e-20, the UE 1e-01 having received the RRCRelease message, may transition to an RRC idle mode or an RRC inactive mode. Specifically, when the RRCRelease message including suspension configuration information (suspendConfig) is received in operation 1e-10, the UE 1e-01 transitions to the RRC inactive mode. Otherwise (e.g., when the RRCRelease message including not including the suspension configuration information is received), the UE 1e-01 may transition to the RRC idle mode.

In operation 1e-25, the UE 1e-01 in the RRC idle mode or the RRC inactive mode may acquire necessary system information. The necessary system information may refer to a master information block (MIB) and system information block 1 (SIB1).

In operation 1e-30, the UE 1e-01 in the RRC idle mode or the RRC inactive mode may perform a cell selection procedure to camp on an NR suitable cell. The cell on which the UE 1e-01 has camped may be referred to as a serving cell.

In the disclosure, a cell that satisfies the conditions in [Table 1] below, based on the 3GPP standard document “38.304: User Equipment (UE) procedures in Idle mode and RRC Inactive state.” may be defined as a suitable cell.

TABLE 1
suitable cell:

For UE not operating in SNPN Access Mode, a cell is considered as suitable if the following
conditions are fulfilled:
The cell is part of either the selected PLMN or the registered PLMN or PLMN of the
Equivalent PLMN list, and for that PLMN either:
The PLMN-ID of that PLMN is broadcast by the cell with no associated CAG-IDs and
CAG-only indication in the UE for that PLMN (TS 23.501 [10]) is absent or false;
Allowed CAG list in the UE for that PLMN (TS 23.501 [10]) includes a CAG-ID broadcast
by the cell for that PLMN;
The cell selection criteria are fulfilled, see clause 5.2.3.2.
According to the latest information provided by NAS:
The cell is not barred, see clause 5.3.1;
The cell is part of at least one TA that is not part of the list of “Forbidden Tracking Areas
for Roaming” (TS 22.011 [18]), which belongs to a PLMN that fulfils the first bullet above.
For UE operating in SNPN Access Mode, a cell is considered as suitable if the following
conditions are fulfilled:
The cell is part of either the selected SNPN or the registered SNPN of the UE;
The cell selection criteria are fulfilled, see clause 5.2.3.2;
According to the latest information provided by NAS:
The cell is not barred, see clause 5.3.1;
The cell is part of at least one TA that is not part of the list of “Forbidden Tracking Areas
for Roaming” which belongs to either the selected SNPN or the registered SNPN of the
UE.

For reference, the UE 1e-01 may determine that cell selection criteria are fulfilled if [Equation 1] below is satisfied.

$$Srxlev > 0 AND Squal > 0 \qquad [ Equation 1 ]$$

where

$$Srxlev = {Q}_{rxlevmeas} - ( {Q}_{rxlevmin} + {Q}_{rslevminoffset} ) - {P}_{compensation} - {Qoffset}_{temp} ,$$

$$Squal = {Q}_{qualmeas} - ( {Q}_{qualmin} + {Q}_{qualminoffset} ) - {Qoffset}_{temp} .$$

Definitions of the parameters used herein are referenced in the 3GPP standard document “38.304: User Equipment (UE) procedures in Idle mode and RRC Inactive state.”

In operation 1e-35, the UE 1e-01 in the RRC idle mode or the RRC inactive mode may acquire system information (e.g., SIB2, SIB3, SIB4, or SIB5) including cell reselection information from the serving cell 1e-02 in order to perform a cell reselection evaluation procedure. SIB2 may include information/a parameter that is commonly applied when the UE 1e-01 reselects an NR intra-frequency cell, an NR inter-frequency cell, and an inter-RAT frequency cell, and include NR intra-frequency cell reselection information except for information related to NR intra-frequency neighboring cells. For example, SIB2 may include one piece of cell reselection priority configuration information relating to a serving NR frequency (i.e., the frequency to which the currently camped-on cell belongs). The cell reselection priority configuration information may refer to cellReselectionPriority and cellReselectionSubPriority. Specifically, cellReselectionPriority may include an integer value (e.g., one integer value among 0 to 7), and cellReselectionSubPriority may include a fractional value (e.g., one fractional value among 0.2, 0.4, 0.6, and 0.8). If both cellReselectionPriority and cellReselectionSubPriority are signaled, the UE may derive a cell reselection priority value by summing the two values. For reference, a higher cell reselection priority value indicates a higher priority. Specifically, the cell reselection configuration information broadcast in SIB2 may be as shown in [Table 2] below.

TABLE 2

| | |
|---|---|
| SIB2 ::= | SEQUENCE { |
| cellReselectionInfoCommon | SEQUENCE { |
| nrofSS-BlocksToAverage | INTEGER (2..maxNrofSS- |
| BlocksToAverage) | OPTIONAL, -- Need S |
| absThreshSS-BlocksConsolidation | ThresholdNR |

OPTIONAL, -- Need S
rangeToBestCell
OPTIONAL, -- Need R

| | |
|---|---|
| q-Hyst | ENUMERATED { |
| | dB0, dB1, dB2, dB3, dB4, dB5, dB6, |

dB8, dB10,

dB12, dB14, dB16, dB18, dB20, dB22,

dB24},

| | |
|---|---|
| speedStateReselectionPars | SEQUENCE { |
| mobilityStateParameters | MobilityStateParameters, |
| q-HystSF | SEQUENCE { |
| sf-Medium | ENUMERATED {dB−6, dB−4, dB−2, |

dB0},

| | |
|---|---|
| sf-High | ENUMERATED {dB−6, dB−4, dB−2, |

```
dB0}
      }
    }
OPTIONAL, -- Need R
  ...
  },
```

| | |
|---|---|
| cellReselectionServingFreqInfo | SEQUENCE { |
| s-NonIntraSearchP | ReselectionThreshold |

OPTIONAL, -- Need S

| | |
|---|---|
| s-NonIntraSearchQ | ReselectionThresholdQ |

OPTIONAL, -- Need S

| | |
|---|---|
| threshServingLowP | ReselectionThreshold, |
| threshServingLowQ | ReselectionThresholdQ |

OPTIONAL, -- Need R

| | |
|---|---|
| cellReselectionPriority | CellReselectionPriority, |
| cellReselectionSubPriority | CellReselectionSubPriority |

```
OPTIONAL, -- Need R
    ...
  },
```

| | |
|---|---|
| intraFreqCellReselectionInfo | SEQUENCE { |
| q-RxLevMin | Q-RxLevMin, |
| q-RxLevMinSUL | Q-RxLevMin |

OPTIONAL, -- Need R

| | |
|---|---|
| q-QualMin | Q-QualMin |

OPTIONAL, -- Need S

| | |
|---|---|
| s-IntraSearchP | ReselectionThreshold, |
| s-IntraSearchQ | ReselectionThresholdQ |

OPTIONAL, -- Need S

| | |
|---|---|
| t-ReselectionNR | T-Reselection, |
| frequencyBandList | MultiFrequencyBandListNR-SIB |

OPTIONAL, -- Need S

| | |
|---|---|
| frequencyBandListSUL | MultiFrequencyBandListNR-SIB |

OPTIONAL, -- Need R

| | |
|---|---|
| p-Max | P-Max |

OPTIONAL, -- Need S

| | |
|---|---|
| smtc | SSB-MTC |

OPTIONAL, -- Need S

| | |
|---|---|
| ss-RSSI-Measurement | SS-RSSI-Measurement |

OPTIONAL, -- Need R

| | |
|---|---|
| ssb-ToMeasure | SSB-ToMeasure |

OPTIONAL, -- Need S

| | |
|---|---|
| deriveSSB-IndexFromCell | BOOLEAN, |

```
    ...,
    [[
```

| | |
|---|---|
| t-ReselectionNR-SF | SpeedStateScaleFactors |

```
OPTIONAL -- Need N
    ]],
    [[
```

| | |
|---|---|
| smtc2-LP-r16 | SSB-MTC2-LP-r16 |

OPTIONAL, -- Need R

| | |
|---|---|
| ssb-PositionQCL-Common-r16 | SSB-PositionQCL-Relation-r16 |

```
OPTIONAL -- Cond SharedSpectrum
    ]]
  },
  ...,
  [[
```

| | |
|---|---|
| relaxedMeasurement-r16 | SEQUENCE { |
| lowMobilityEvaluation-r16 | SEQUENCE { |
| s-SearchDeltaP-r16 | ENUMERATED { |
| | dB3, dB6, dB9, dB12, dB15, |
| | spare3, spare2, spare1}, |
| t-SearchDeltaP-r16 | ENUMERATED { |
| | s5, s10, s20, s30, s60, s120, s180, |
| | s240, s300, spare7, spare6, spare5, |
| | spare4, spare3, spare2, spare1} |

}
OPTIONAL, -- Need R

| | |
|---|---|
| cellEdgeEvaluation-r16 | SEQUENCE { |
| s-SearchThresholdP-r16 | ReselectionThreshold, |
| s-SearchThresholdQ-r16 | ReselectionThresholdQ |

OPTIONAL -- Need R
}
OPTIONAL, -- Need R

| | |
|---|---|
| combineRelaxedMeasCondition-r16 | ENUMERATED {true} |

OPTIONAL, -- Need R

| | |
|---|---|
| highPriorityMeasRelax-r16 | ENUMERATED {true} |

```
OPTIONAL -- Need R
  }
OPTIONAL -- Need R
  ]]
}
RangeToBestCell ::= Q-OffsetRange
```

SIB3 may include neighboring cell information/parameter for reselecting an NR intra-frequency cell by the UE 1e-01. For example, SIB3 may broadcast an NR intra-frequency cell list (intraFreqNeighCellList) for reselecting an NR intra-frequency cell or an NR intra-frequency black cell list (intraFreqBlackCellList) in which NR intra-frequency cell reselection is not allowed. Specifically, information as shown in [Table 3] below may be broadcast in SIB3.

TABLE 3

| | |
|---|---|
| SIB3 ::= | SEQUENCE { |
| intraFreqNeighCellList | IntraFreqNeighCellList |

OPTIONAL, -- Need R

| | |
|---|---|
| intraFreqBlackCellList | IntraFreqBlackCellList |

OPTIONAL, -- Need R

| | |
|---|---|
| lateNonCriticalExtension | OCTET STRING |

```
OPTIONAL,
  ...,
  [[
```

| | |
|---|---|
| intraFreqNeighCellList-v1610 | IntraFreqNeighCellList-v1610 |

OPTIONAL, -- Need R

| | |
|---|---|
| intraFreqWhiteCellList-r16 | IntraFreqWhiteCellList-r16 |

OPTIONAL, -- Cond SharedSpectrum2

| | |
|---|---|
| intraFreqCAG-CellList-r16 | SEQUENCE (SIZE (1..maxPLMN)) OF |
| IntraFreqCAG-CellListPerPLMN-r16 | OPTIONAL -- Need R |

]]
}

| | |
|---|---|
| IntraFreqNeighCellList ::= | SEQUENCE (SIZE (1..maxCellIntra)) OF |

IntraFreqNeighCellInfo

| | |
|---|---|
| IntraFreqNeighCellList-v1610::= | SEQUENCE (SIZE (1..maxCellIntra)) OF |

IntraFreqNeighCellInfo-v1610

| | |
|---|---|
| IntraFreqNeighCellInfo ::= | SEQUENCE { |
| physCellId | PhysCellId, |
| q-OffsetCell | Q-OffsetRange, |
| q-RxLevMinOffsetCell | INTEGER (1..8) |

OPTIONAL, -- Need R

| | |
|---|---|
| q-RxLevMinOffsetCellSUL | INTEGER (1..8) |

OPTIONAL, -- Need R

| | |
|---|---|
| q-QualMinOffsetCell | INTEGER (1..8) |

OPTIONAL, -- Need R
...
}

| | |
|---|---|
| IntraFreqNeighCellInfo-v1610 ::= | SEQUENCE { |
| ssb-PositionQCL-r16 | SSB-PositionQCL-Relation-r16 |

OPTIONAL -- Cond SharedSpectrum2
}

| | |
|---|---|
| IntraFreqBlackCellList ::= | SEQUENCE (SIZE (1..maxCellBlack)) OF PCI-Range |
| IntraFreqWhiteCellList-r16 ::= | SEQUENCE (SIZE (1..maxCellWhite)) OF PCI-Range |

IntraFreqCAG-CellListPerPLMN-r16 ::= SEQUENCE {

| | |
|---|---|
| plmn-Identity Index-r16 | INTEGER (1..maxPLMN), |
| cag-CellList-r16 | SEQUENCE (SIZE (1..maxCAG-Cell-r16)) OF |

PCI-Range
}

SIB4 may include information/a parameter for reselecting an NR inter-frequency cell by the UE 1e-01. For example, SIB4 may broadcast one or multiple NR inter-frequencies, and may broadcast one piece of cell reselection priority configuration information for each NR inter-frequency. The cell reselection priority configuration information for each NR inter-frequency refers to the aforementioned content (e.g., cellReselectionPriority and/or cellReselectionSubPriority mapped to each NR inter-frequency), but one piece of cell reselection priority configuration information for each NR inter-frequency may be optionally broadcast. Specifically, information as shown in [Table 4] below may be broadcast in SIB4.

TABLE 4

| | |
|---|---|
| SIB4 ::= | SEQUENCE { |
| interFreqCarrierFreqList | InterFreqCarrierFreqList, |
| lateNonCriticalExtension | OCTET STRING |

```
OPTIONAL,
  ...,
  [[
```

| | |
|---|---|
| interFreqCarrierFreqList-v1610 | InterFreqCarrierFreqList-v1610 |

OPTIONAL -- Need R
]]
}

| | |
|---|---|
| InterFreqCarrierFreqList ::= | SEQUENCE (SIZE (1..maxFreq)) OF |

InterFreqCarrierFreqInfo

| | |
|---|---|
| InterFreqCarrierFreqList-v1610 ::= | SEQUENCE (SIZE (1..maxFreq)) OF |

InterFreqCarrierFreqInfo-v1610

| | |
|---|---|
| InterFreqCarrierFreqInfo ::= | SEQUENCE { |
| dl-CarrierFreq | ARFCN-ValueNR, |
| frequencyBandList | MultiFrequencyBandListNR-SIB |

OPTIONAL, -- Cond Mandatory

| | |
|---|---|
| frequencyBandListSUL | MultiFrequencyBandListNR-SIB |

OPTIONAL, -- Need R

| | |
|---|---|
| nrofSS-BlocksToAverage | INTEGER (2..maxNrofSS-BlocksToAverage) |

OPTIONAL, -- Need S

| | |
|---|---|
| absThreshSS-BlocksConsolidation | ThresholdNR |

OPTIONAL, -- Need S

| | |
|---|---|
| smtc | SSB-MTC |

OPTIONAL, -- Need S

| | |
|---|---|
| ssbSubcarrierSpacing | SubcarrierSpacing, |
| ssb-ToMeasure | SSB-ToMeasure |

OPTIONAL, -- Need S

| | |
|---|---|
| deriveSSB-IndexFromCell | BOOLEAN, |
| ss-RSSI-Measurement | SS-RSSI-Measurement |

OPTIONAL,

| | |
|---|---|
| q-RxLevMin | Q-RxLevMin, |
| q-RxLevMinSUL | Q-RxLevMin |

OPTIONAL, -- Need R

| | |
|---|---|
| q-QualMin | Q-QualMin |

OPTIONAL, -- Need S

| | |
|---|---|
| p-Max | P-Max |

OPTIONAL, -- Need S

| | |
|---|---|
| t-ReselectionNR | T-Reselection, |
| t-ReselectionNR-SF | SpeedStateScaleFactors |

OPTIONAL, -- Need S

| | |
|---|---|
| threshX-HighP | ReselectionThreshold, |
| threshX-LowP | ReselectionThreshold, |
| threshX-Q | SEQUENCE { |
| threshX-HighQ | ReselectionThresholdQ, |
| threshX-LowQ | ReselectionThresholdQ |

}
OPTIONAL, -- Cond RSRQ

| | |
|---|---|
| cellReselectionPriority | CellReselectionPriority |

OPTIONAL, -- Need R

| | |
|---|---|
| cellReselectionSubPriority | CellReselectionSubPriority |

OPTIONAL, -- Need R

| | |
|---|---|
| q-OffsetFreq | Q-OffsetRange |

DEFAULT dB0,

| | |
|---|---|
| interFreqNeighCellList | InterFreqNeighCellList |

OPTIONAL, -- Need R

| | |
|---|---|
| interFreqBlackCellList | InterFreqBlackCellList |

OPTIONAL, -- Need R
...
}

| | |
|---|---|
| InterFreqCarrierFreqInfo-v1610 ::= | SEQUENCE { |
| interFreqNeighCellList-v1610 | InterFreqNeighCellList-v1610 |

OPTIONAL, -- Need R

| | |
|---|---|
| smtc2-LP-r16 | SSB-MTC2-LP-r16 |

OPTIONAL, -- Need R

| | |
|---|---|
| interFreqWhiteCellList-r16 | InterFreqWhiteCellList-r16 |

OPTIONAL, -- Cond SharedSpectrum2

| | |
|---|---|
| ssb-PositionQCL-Common-r16 | SSB-PositionQCL-Relation-r16 |

OPTIONAL, -- Cond SharedSpectrum

| | |
|---|---|
| interFreqCAG-CellList-r16 | SEQUENCE (SIZE (1..maxPLMN)) OF |
| InterFreqCAG-CellListPerPLMN-r16 | OPTIONAL -- Need R |

}

| | |
|---|---|
| InterFreqNeighCellList ::= | SEQUENCE (SIZE (1..maxCellInter)) OF |

InterFreqNeighCellInfo

| | |
|---|---|
| InterFreqNeighCellList-v1610 ::= | SEQUENCE (SIZE (1..maxCellInter)) OF |

InterFreqNeighCellInfo-v1610

| | |
|---|---|
| InterFreqNeighCellInfo ::= | SEQUENCE { |
| physCellId | PhysCellId, |
| q-OffsetCell | Q-OffsetRange, |
| q-RxLevMinOffsetCell | INTEGER (1..8) |

OPTIONAL, -- Need R

| | |
|---|---|
| q-RxLevMinOffsetCellSUL | INTEGER (1..8) |

OPTIONAL, -- Need R

| | |
|---|---|
| q-QualMinOffsetCell | INTEGER (1..8) |

OPTIONAL, -- Need R
...
}

| | |
|---|---|
| InterFreqNeighCellInfo-v1610 ::= | SEQUENCE { |
| ssb-PositionQCL-r16 | SSB-PositionQCL-Relation-r16 |

OPTIONAL -- Cond SharedSpectrum2
}

| | |
|---|---|
| InterFreqBlackCellList ::= | SEQUENCE (SIZE (1..maxCellBlack)) OF PCI-Range |
| InterFreqWhiteCellList-r16 ::= | SEQUENCE (SIZE (1..maxCellWhite)) OF PCI-Range |

InterFreqCAG-CellListPerPLMN-r16 ::= SEQUENCE {

| | |
|---|---|
| plmn-IdentityIndex-r16 | INTEGER (1..maxPLMN), |
| cag-CellList-r16 | SEQUENCE (SIZE (1..maxCAG-Cell-r16)) OF PCI- |

Range
}

SIB5 may include information/a parameter for reselecting an inter-RAT frequency cell by the UE 1e-01. For example, SIB5 may broadcast one or multiple EUTRA frequencies, and may broadcast one piece of cell reselection priority configuration information for each EUTRA frequency. The cell reselection priority configuration information for each EUTRA frequency refers to the aforementioned content (e.g., cellReselectionPriority and/or cell ReselectionSubPriority mapped to each EUTRA frequency), but one piece of cell reselection priority configuration information for each EUTRA frequency may be optionally broadcast. Specifically, information as shown in [Table 5] below may be broadcast in SIB5.

TABLE 5

| | |
|---|---|
| SIB5 ::= | SEQUENCE { |
| carrierFreqListEUTRA | CarrierFreqListEUTRA |

OPTIONAL, -- Need R

| | |
|---|---|
| t-ReselectionEUTRA | T-Reselection, |
| t-ReselectionEUTRA-SF | SpeedStateScaleFactors |

OPTIONAL, -- Need S

| | |
|---|---|
| lateNonCriticalExtension | OCTET STRING |

```
OPTIONAL,
  ...,
  [[
```

| | |
|---|---|
| carrierFreqListEUTRA-v1610 | CarrierFreqListEUTRA-v1610 |

OPTIONAL -- Need R
]]
}

| | |
|---|---|
| CarrierFreqListEUTRA ::= | SEQUENCE (SIZE (1..maxEUTRA-Carrier)) OF |

CarrierFreqEUTRA

| | |
|---|---|
| CarrierFreqListEUTRA-v1610 ::= | SEQUENCE (SIZE (1..maxEUTRA-Carrier)) OF |

CarrierFreqEUTRA-v1610

| | |
|---|---|
| CarrierFreqEUTRA ::= | SEQUENCE { |
| carrierFreq | ARFCN-ValueEUTRA, |
| eutra-multiBandInfoList | EUTRA-MultiBandInfoList |

OPTIONAL, -- Need R

| | |
|---|---|
| eutra-FreqNeighCellList | EUTRA-FreqNeighCellList |

OPTIONAL, -- Need R

| | |
|---|---|
| eutra-BlackCellList | EUTRA-FreqBlackCellList |

OPTIONAL, -- Need R

| | |
|---|---|
| allowedMeasBandwidth | EUTRA-AllowedMeasBandwidth, |
| presenceAntennaPort1 | EUTRA-PresenceAntennaPort1, |
| cellReselectionPriority | CellReselectionPriority |

OPTIONAL, -- Need R

| | |
|---|---|
| cellReselectionSubPriority | CellReselectionSubPriority |

OPTIONAL, -- Need R

| | |
|---|---|
| threshX-High | ReselectionThreshold, |
| threshX-Low | ReselectionThreshold, |
| q-RxLevMin | INTEGER (−70..−22), |
| q-QualMin | INTEGER (−34..−3), |
| p-MaxEUTRA | INTEGER (−30..33), |
| threshX-Q | SEQUENCE { |
| threshX-HighQ | ReselectionThresholdQ, |
| threshX-LowQ | ReselectionThresholdQ |

```
  }
OPTIONAL -- Cond RSRQ
  }
CarrierFreqEUTRA-v1610 ::= SEQUENCE {
```

| | |
|---|---|
| highSpeedEUTRACarrier-r16 | ENUMERATED {true} |

OPTIONAL -- Need R
}

| | |
|---|---|
| EUTRA-FreqBlack CellList ::= | SEQUENCE (SIZE (1..maxEUTRA-CellBlack)) OF |

EUTRA-PhysCellIdRange

| | |
|---|---|
| EUTRA-FreqNeighCellList ::= | SEQUENCE (SIZE (1..maxCellEUTRA)) OF EUTRA- |

FreqNeighCellInfo

| | |
|---|---|
| EUTRA-FreqNeighCellInfo ::= | SEQUENCE { |
| physCellId | EUTRA-PhysCellId, |
| dummy | EUTRA-Q-OffsetRange, |
| q-RxLevMinOffsetCell | INTEGER (1..8) |

OPTIONAL, -- Need R

| | |
|---|---|
| q-QualMinOffsetCell | INTEGER (1..8) |

OPTIONAL -- Need R
}

The UE 1e-01 in the RRC idle mode or the RRC inactive mode may perform a cell reselection evaluation procedure (process). The cell reselection evaluation procedure may refer to a series of processes including determining (handling) reselection priorities, performing frequency measurement by applying measurement rules (measurement rules for cell re-selection) according to the determined reselection priorities, and evaluating cell reselection criteria to reselect a cell accordingly.

In operation 1e-40, the UE 1e-01 in the RRC idle mode or the RRC inactive mode may derive a reselection priority, based on the system information received in operation 1e-25. The UE 1e-01 may determine a reselection priority only for a frequency for which a cell reselection priority value is broadcast in the system information. The UE 1e-01 according to the disclosure may determine, based on a cell reselection priority value mapped to an NR frequency to which a serving cell on which the UE is currently camping on belongs, whether a cell reselection priority for each NR inter-frequency or inter-RAT frequency is equal to, higher than, or lower than the cell reselection priority of the NR frequency to which the serving cell belongs. For example, if, in the system information acquired in operation 1e-25, the cell reselection priority value mapped to the NR frequency to which the currently camped-on serving cell belongs is 3, and the cell reselection priority value of inter NR frequency 1 is 2, the cell reselection priority value of inter NR frequency 2 is 3, the cell reselection priority value of inter NR frequency 3 is 4, and the cell reselection priority value of EUTRA frequency 1 is 2, the UE 1e-01 may determine that inter NR frequency 1 and EUTRA frequency 1 have a lower cell reselection priority (lower reselection priority), the cell reselection priority of inter NR frequency 2 is equal (an equal reselection priority), and the cell reselection priority of inter NR frequency 3 is a higher cell reselection priority (higher reselection priority).

In operation 1e-45, the UE 1e-01 in the RRC idle mode or the RRC inactive mode may perform frequency measurement for cell reselection. In this case, the UE 1e-01 may perform the frequency measurement by using the following measurement rule according to the cell reselection priorities determined in operation 1e-40, in order to minimize battery consumption.

If condition 1 below is satisfied, the UE 1e-01 may not perform NR intra-frequency measurement. Otherwise (e.g., when condition 1 below is not satisfied), the UE 1e-01 performs NR intra-frequency measurement.

Condition 1: The reception level (Srxlev) of the serving cell is greater than an SIntraSearchP threshold value and the reception quality (Squal) of the serving cell is greater than an SIntraSearchQ threshold value (Serving cell fulfils Srxlev>SIntraSearchP and Squal>SIntraSearchQ).
For an NR inter-frequency or inter-RAT frequency having a reselection priority higher than that of the NR frequency of the current serving cell, the UE may perform measurement according to the 3GPP TS 38.133 specification.
For an NR inter-frequency having a reselection priority equal to or lower than that of the NR frequency of the current serving cell, and for an inter-RAT frequency having a reselection priority lower than that of the NR frequency of the current serving cell, the UE 1e-01 may not perform measurement if condition 2 below is satisfied. Otherwise (e.g., when condition 2 below is not satisfied), the UE 1e-01 measures cells on the NR inter-frequency having a reselection priority equal to or lower than that of the NR frequency, or measures cells on the inter-RAT frequency having a reselection priority lower than that of the NR frequency.

Condition 2: The reception level (Srxlev) of the serving cell is greater than an SnonIntraSearchP threshold value and the reception quality (Squal) of the serving cell is greater than an SnonIntraSearchQ threshold value (Serving cell fulfils Srxlev>SnonIntraSearchP and Squal>SnonIntraSearchQ).

For reference, the above threshold values (SintraSearchP, SintraSearchQ, SnonintraSearchP, and SnonintraSearchQ) may be broadcast in the system information obtained in operation 1e-25.

In operation 1e-50, the UE 1e-01 in the RRC idle mode or the RRC inactive mode may determine to reselect a cell that satisfies cell reselection criteria, based on the measurement results obtained in operation 1e-45. Different cell reselection criteria may be applied depending on the cell reselection priorities. If multiple cells that satisfy the cell reselection criteria have different cell reselection priorities, reselecting a frequency/RAT cell having a higher cell reselection priority precedes reselecting a frequency/RAT cell having a lower priority (Cell reselection to a higher priority RAT/frequency shall take precede over a lower priority RAT/frequency if multiple cells of different priorities fulfil the cell reselection criteria). Specifically, an operation of the UE for the cell reselection criteria of an inter-frequency/inter-RAT cell having a higher priority than that of the frequency of the current serving cell is as follows.

### First Operation:

If a threshold value for Thresh_{Serving,LowQ} is included and broadcast in SIB2, and a predetermined time (e.g., 1 second) elapses after the UE has camped on the current serving cell, when the signal quality (Squal) of an inter-frequency/inter-RAT cell is greater than a threshold value Thresh_{X,HighQ} during a particular time Treselection_{RAT} (Squal>Thresh_{X,HighQ} during a time interval Treselection_{RAT}), the UE may reselect the inter-frequency/inter-RAT cell.

### Second Operation:

If the UE 1e-01 fails to perform the first operation, the UE performs the second operation.

If a predetermined time (e.g., 1 second) elapses after the UE 1e-01 has camped on the current serving cell, and the reception level (Srxlev) of an inter-frequency/inter-RAT cell is greater than a threshold value Thresh_{X,HighP} during a particular time Treselection_{RAT} (Srxlev>Thresh_{X,HighP} during a time interval Treselection_{RAT}), the UE may reselect the inter-frequency/inter-RAT cell.

The UE 1e-01 may perform the first operation or the second operation, based on the information included in SIB4 broadcast by the serving cell, as a signal quality (Squal) of an inter-frequency cell, a reception level (Srxlev), threshold values (Thresh_{X,HighQ} and Thresh_{X,HighP}), and Treselection_{RAT} values. In addition, the UE 1e-01 may perform the first operation or the second operation, based on the information included in SIB5 broadcast by the serving cell, as a signal quality (Squal) of an inter-RAT cell, a reception level (Srxlev), threshold values (Thresh_{X,HighQ} and Thresh_{X,HighP}), and Treselection_{RAT} values. For example, SIB4 may include a Q_{qualmin} value and a Qᵣₓₗₑᵥₘᵢₙ value and, based on the values, the signal quality (Squal) or reception level (Srxlev) of an inter-frequency cell are derived. If there are multiple cells on an NR frequency satisfying a higher cell reselection priority, the UE 1e-01 may reselect a highest ranked cell among cells that satisfy the reselection criteria of an intra-frequency/inter-frequency cell having the same priority as that of the frequency of the current serving cell.

Additionally, an operation of the UE 1e-01 for the reselection criteria of an intra-frequency/inter-frequency cell having the same priority as that of the frequency of the current serving cell is as follows.

### Third Operation:

If the signal quality (Squal) and signal level (Srxlev) of an intra-frequency/inter-frequency cell are greater than 0, the UE derives the rank of each cell, based on a measurement value (RSRP) (The UE shall perform ranking of all cells that fulfills the cell selection criterion S). The ranks of the serving cell and a neighboring cell may be calculated according to [Equation 2], respectively.

$$Rs = Qmeas , s + Qhyst \qquad [ Equation 2 ]$$

$$Rn = Qmeas , n - Qoffset$$

Where Qmeas,s is an RSRP measurement value of the serving cell, Qmeas,n is an RSRP measurement value of a neighboring cell, Qhyst is a hysteresis value of the serving cell, and Qoffset is an offset between the serving cell and the neighboring cell. A Qhyst value is included in SIB2, and the value is commonly used for reselection of an intra-frequency/inter-frequency cell. For reselection of an intra-frequency cell, Qoffset is signaled per cell, is applied only to an indicated cell, and is included in SIB3. For reselection of an inter-frequency cell, Qoffset is signaled per cell, is applied only to an indicated cell, and is included in SIB4. If the rank of a neighboring cell obtained from [Equation 2] is greater than the rank of the serving cell (Rn>Rs), the UE may reselect an optimal cell among neighboring cells.

In addition, an operation of the UE for the reselection criteria of an inter-frequency/inter-RAT cell having a lower priority than that of the frequency of the current serving cell is as follows.

### Forth Operation:

If a threshold value for Thresh_{Serving,LowQ} is included and broadcast in SIB2, and a predetermined time (e.g., 1 second) elapses after the UE 1e-01 has camped on the current serving cell, when the signal quality (Squal) of the current serving cell is smaller than a threshold Thresh_{Serving,LowQ} (Squal<Thresh_{Serving,LowQ}), and the signal quality (Squal) of an inter-frequency/inter-RAT cell is greater than a threshold value Thresh_{X,LowQ} during a particular time Treselection_{RAT} (Squal>Thresh_{X,LowQ} during a time interval Treselection_{RAT}), the UE may reselect the inter-frequency/inter-RAT cell.

### Fifth Operation:

If the UE 1e-01 fails to perform the fourth operation, the UE performs the fifth operation.

If a predetermined time (e.g., 1 second) elapses after the UE 1e-01 has camped on the current serving cell, the reception level (Srxlev) of the current serving cell is smaller than a threshold Thresh_{Serving,LowP} (Srxlev<Thresh_{Serving,LowP}), and the reception level (Srxlev) of an inter-frequency/inter-RAT cell is greater than a threshold value Thresh_{X,LowQ} during a particular time Treselection_{RAT} (Srxlev>Thresh_{X,LowP} during a time interval Treselection_{RAT}), the UE may reselect the inter-frequency/inter-RAT cell.

The UE 1e-01 may perform the fourth operation or the fifth operation for an inter-frequency cell, based on the threshold values (Thresh_{Serving,LowQ} and Thresh_{Serving, LowP}) included in SIB2 broadcast by the serving cell, and the signal quality (Squal) of the inter-frequency cell, the reception level (Srxlev), the threshold values (Thresh_{X,lowQ} and Thresh_{X,LowP}), and Treselection_{RAT}, which are included in SIB4 broadcast by the serving cell. The UE 1e-01 may perform the fourth operation or the fifth operation for an inter-RAT cell, based on the threshold values (Thresh_{Serving,LowQ} and Thresh_{Serving,LowP}) included in SIB2 broadcast by the serving cell, and the signal quality (Squal) of the inter-RAT cell, the reception level (Srxlev), the threshold values (Thresh_{X,LowQ} and Thresh_{X,LowP}), and Treselection_{RAT}, which are included in SIB5 broadcast by the serving cell. For example, SIB4 may include a Q_{qualmin} value and a Qᵣₓₗₑᵥₘᵢₙ value, and the UE 1e-01 derives the signal quality (Squal) or signal level (Srxlev) of an inter-frequency cell, based on the values. If there are multiple cells on an NR frequency satisfying a higher cell reselection priority, the UE 1e-01 may reselect a highest ranked cell among cells that satisfy the reselection criteria of an intra-frequency/inter-frequency cell having the same priority as that of the frequency of the current serving cell. Of course, if a candidate cell on a frequency having a higher or lower priority than that of the frequency of the current serving cell is derived by satisfying the above conditions, the UE may reselect the candidate cell as the best cell (or the strongest cell).

In operation 1e-55, the UE 1e-01 in the RRC idle mode or the RRC inactive mode receives system information (e.g., MIB or SIB1) broadcast by a candidate target cell before finally reselecting the candidate target cell, and determines whether the reception level (Srxlev) and signal quality (Squal) of the candidate target cell satisfy a cell selection criterion referred to as an S-criterion [Equation 1] (Srxlev>0 AND Squal>0), based on the received system information. If [Equation 1] is satisfied and the candidate target cell is suitable, the UE 1e-01 may reselect the candidate target cell.

FIG. 1F is a diagram illustrating a concept of cell discontinuous transmission (DTX)/cell discontinuous reception (DRX) according to an embodiment of the disclosure.

A network energy saving (NES) cell 1f-01 that supports cell DTX/DRX may transmit and/or receive a signal only during a specific period for the purpose of reducing power consumption of network equipment. For example, the NES cell 1f-01 may transmit a signal in cell DTX/DRX active periods 1f-15, 1f-25, and 1f-35 (1f-45), and receive a signal from an NES UE 1f-02 (1f-50). In contrast, the NES cell 1f-01 that does not support a low-power or wake-up signal receiver (WUR) 1f-02 may neither transmit a signal nor receive any signal from the UE during cell DTX/DRX non-active periods 1f-10, 1f-20, 1f-30, and 1f-40. The NES cell 1f-01 supporting the WUR 1f-02 may not transmit a signal in the cell DTX/DRX non-active periods 1f-10, 1f-20, 1f-30, and 1f-40, but receive a wake-up signal from the NES UE 1f-03 (1f-50). When a wake-up signal is received from the NES UE 1f-03, the NES cell 1f-01 switches from a cell DTX/DRX non-active period to a cell DTX/DRX active period to be able to not only transmit a signal but also receive signals other than a wake-up signal from the NES UE, thereby enabling data communication with the NES UE 1f-03. For reference, the NES cell 1f-01 that supports the WUR 1f-02 may have a separate period within a cell DTX or cell DRX non-active period, where reception of a wake-up signal from the NES UE 1f-03 is possible. The NES cell 1f-01 may broadcast an indicator for indicating support of a cell DTX/DRX function in system information (e.g., MIB or SIB1). The NES cell 1f-01 may activate cell DTX/DRX according to a specific pattern and may include and broadcast the pattern in the system information. For example, the NES cell 1f-01 may include and broadcast, in the system information, the periodicity of a cell DTX/DRX active period, a start slot/offset indicating a start time point, and a cell DTX/DRX on duration. Accordingly, the NES UE 1f-03 may synchronize with the NES cell 1f-01, measure the NES cell 1f-01, camp on the NES cell 1f-01, or reselect the NES cell 1f-01. Additionally, pieces of information enabling reception of a wake-up signal during a cell DTX or cell DRX non-active period may also separately be included and broadcast in the system information. That is, the system information may include a periodicity for receiving a wake-up signal, a start slot/offset indicating a start time point, and a wake-up on duration.

For reference, a legacy UE 1f-04, which is not the NES UE 1f-03, may bar the NES cell 1f-01. For example, the legacy UE 1f-04 may bar the NES cell 1f-01 from being subject to cell (re)selection, through information included in a MIB broadcast by the NES cell 1f-01.

FIG. 1G is a diagram illustrating a method of, when a NES cell that is a current serving cell is in a DTX/DRX non-active period, accessing a cell by a NES UE according to an embodiment of the disclosure.

In the disclosure, a NES UE in an RRC idle mode (RRC_IDLE) or an RRC inactive mode (RRC_INACTIVE) may have a cell supporting cell DTX/DRX, as a current serving cell. In the disclosure, when the UE has camped on a cell in a cell DTX/DRX active period and has regarded the cell as a serving cell, then later, the cell enters a cell DTX/DRX non-active period, and the UE needs to access a cell, whether the UE is required to perform cell reselection or is required to wait until the cell enters a cell DTX/DRX active period and then access the serving cell supporting cell DTX/DRX through a random access procedure is described.

Referring to FIG. 1G, in operation 1g-05, a NES UE 1g-01 may be in an RRC idle mode or an RRC inactive mode.

In an operation 1g-10, the NES UE 1g-01 in the RRC idle mode or the RRC inactive mode may acquire necessary system information from a NES cell 1g-02 supporting cell DTX/DRX. The necessary system information may refer to a master information block (MIB) and system information block 1 (SIB1). The necessary system information may include at least one of the following.
An indicator indicating whether the cell supports a cell DTX/DRX function
Cell DTX/DRX pattern information
A periodicity of a cell DTX/DRX active period or cell DTX/DRX non-active period
An offset or one of a slot, subframe, and radio frame indicating a time point at which a cell DTX/DRX active period or cell DTX/DRX non-active period starts
A cell DTX/DRX active period or cell DTX/DRX non-active period on duration

In operation 1g-15, the NES UE 1g-01 in the RRC idle mode or the RRC inactive mode may perform a cell selection procedure to camp on an NR suitable cell supporting a cell DTX/DRX function. The cell on which the NES UE 1g-01 has camped may be referred to as a serving cell. This may follow the above embodiment.

In operation 1g-35, the NES UE 1g-01 in the RRC idle mode or the RRC inactive mode may acquire system information (e.g., SIB2, SIB3, SIB4, SIB5, or a new SIB) including cell reselection information from the serving cell 1g-02, which is a NES cell supporting cell DTX/DRX, in order to perform a cell reselection evaluation procedure. This may follow the above embodiment.

In operation 1g-25, the UE 1g-01 in the RRC idle mode or the RRC inactive mode may perform a cell reselection evaluation procedure (process). This may follow the above embodiment.

In operation 1g-30, the NES UE 1g-01 may be in anon-active period. That, as a cell DTX/DRX non-active period of the serving cell starts, the UE may be in a non-active period. In the disclosure, the NES UE 1g-01 may not perform cell reselection until the NES UE needs to access a cell. However, the NES UE 1g-01 may still perform a cell reselection evaluation procedure for cell reselection, but may not perform cell reselection when there is no need to access a cell. Alternatively, the NES UE 1g-01 may not perform cell reselection when the serving cell 1g-02, which is a NES cell supporting cell DTX/DRX, is in a cell DTX/DRX active period and the most recent signal of the serving cell has a value better than a certain threshold value, or when the serving cell satisfies the above-described frequency measurement rules and thus neighboring cell measurement is not performed.

In operation 1g-35, the NES UE 1g-01 may need to access a cell. For example, when the NES UE 1g-01 is requested by UE upper layer devices (upper layers) to configure an RRC connection or initiate an RRC connection resume procedure, or when the NES UE is requested by an RRC layer device to initiate an RRC connection resume procedure, the NES UE 1g-01 may need to access a cell.

In an operation 1g-40, the NES UE 1g-01 may perform the following series of procedures.
The NES UE 1g-01 may check whether there is another suitable cell. If possible, the NES UE 1g-01 may select or reselect another suitable cell. Then, the NES UE may initiate a random access procedure for the selected or reselected cell to configure or resume an RRC connection.
If the NES UE 1g-01 determines that no suitable cell exists, the NES UE 1g-01 may wait until the current serving cell 1g-02 enters a cell DTX/DRX active period, and when the serving cell 1g-02 enters the cell DTX/DRX active period, initiate a random access procedure for the serving cell to configure or resume an RRC connection.

For reference, the content related to initiating a random access procedure to configure or resume an RRC connection may follow an embodiment described later. When the NES UE 1g-01 needs to access a cell while the current serving cell 1g-02 is in a cell DTX/DRX active period, the NES UE may initiate a random access procedure for the serving cell 1g-02 to configure or resume an RRC connection.

FIG. 1H is a diagram illustrating a method of, when a NES cell that is a current serving cell is in a cell DTX/DRX non-active period, accessing a cell by a NES UE according to an embodiment of the disclosure.

In the disclosure, a NES UE in an RRC idle mode (RRC_IDLE) or an RRC inactive mode (RRC_INACTIVE) may have a cell supporting cell DTX/DRX, as a current serving cell. In the disclosure, when the UE has camped on a cell in a cell DTX/DRX active period and has regarded the cell as a serving cell, then later, the cell enters a cell DTX/DRX non-active period, and the UE needs to access a cell, whether the UE is required to perform cell reselection or is required to wait until the cell enters a cell DTX/DRX active period and then access the serving cell supporting cell DTX/DRX through a random access procedure is described.

Referring to FIG. 1H, in operation 1h-10, a NES UE 1h-01 may be in an RRC idle mode or an RRC inactive mode.

In an operation 1h-10, the UE in the RRC idle mode or the RRC inactive mode may acquire necessary system information from a NES cell 1h-02 supporting cell DTX/DRX. The necessary system information may refer to a master information block (MIB) and system information block 1 (SIB1). The necessary system information may include at least one of the following.
An indicator indicating whether the cell supports a cell DTX/DRX function
Cell DTX/DRX pattern information
A periodicity of a cell DTX/DRX active period or cell DTX/DRX non-active period
An offset or one of a slot, subframe, and radio frame indicating a time point at which a cell DTX/DRX active period or cell DTX/DRX non-active period starts
A cell DTX/DRX active period or cell DTX/DRX non-active period on duration
A threshold value for a remaining cell DTX/DRX non-active period
If the remaining cell DTX/DRX non-active period of the current serving cell is less than or is less than or equal to the threshold value, the UE may wait until the current serving cell enters a cell DTX/DRX active period and then access the current serving cell. Otherwise, the UE may select or reselect a cell and access the selected or reselected cell.

In operation 1h-15, the NES UE 1g-01 in the RRC idle mode or the RRC inactive mode may perform a cell selection procedure to camp on an NR suitable cell supporting a cell DTX/DRX function. The cell on which the NES UE 1g-01 has camped may be referred to as a serving cell. This may follow the above embodiment.

In operation 1h-35, the NES UE 1h-01 in the RRC idle mode or the RRC inactive mode may acquire system information (e.g., SIB2, SIB3, SIB4, SIB5, or a new SIB) including cell reselection information from the serving cell 1h-02, which is a NES cell supporting cell DTX/DRX, in order to perform a cell reselection evaluation procedure. This may follow the above embodiment. Additionally, the system information may include the following information.
A threshold value for a remaining cell DTX/DRX non-active period

In operation 1h-25, the UE 1h-01 in the RRC idle mode or the RRC inactive mode may perform a cell reselection evaluation procedure (process). This may follow the above embodiment.

In operation 1h-30, the NES UE 1h-01 may be in anon-active period. That, as a cell DTX/DRX non-active period of the serving cell starts, the NES UE 1h-01 may be in a non-active period.

In operation 1h-35, the NES UE 1h-01 may need to access a cell. For example, when the NES UE 1h-01 is requested by UE upper layer devices (upper layers) to configure an RRC connection or initiate an RRC connection resume procedure, or when the NES UE is requested by an RRC layer device to initiate an RRC connection resume procedure, the NES UE 1h-01 may need to access a cell.

In operation 1b-40, the NES UE 1h-01 may perform the following series of procedures.
If the remaining cell DTX/DRX non-active period of the current serving cell 1h-02 is less than or is less than or equal to the threshold value for a remaining cell DTX/DRX non-active period, the NES UE 1h-01 may wait until the current serving cell 1h-02 is switched to a cell DTX/DRX active period, and then initiate an access procedure for the cell to configure or resume an RRC connection. Otherwise, the NES UE 1h-01 may perform a cell selection or reselection process to initiate an access procedure for the selected or reselected cell to configure or resume an RRC connection.

For reference, the threshold value for a remaining cell DTX/DRX non-active period may be configured by a dedicated RRC message or may be a fixed value internally determined in the UE or specified in a specification. Alternatively, if the time taken to perform cell selection or reselection is longer than the remaining cell DTX/DRX non-active period, the NES UE 1h-01 may wait until the current serving cell 1h-02 is switched to a cell DTX/DRX active period, and then initiate an access procedure for the cell to configure or resume an RRC connection. That is, when accessing the current serving cell after the cell is switched to a cell DTX/DRX active period is faster than performing cell selection or reselection, the UE may access the current serving cell.

FIG. 1I is a diagram illustrating a method of, when a NES cell that is a current serving cell is in a cell DTX/DRX non-active period, accessing a cell by a NES UE according to an embodiment of the disclosure.

In the disclosure, a NES UE in an RRC idle mode (RRC_IDLE) or an RRC inactive mode (RRC_INACTIVE) may have a cell supporting at least cell DTX, as a current serving cell. In the disclosure, a situation where the UE has camped on the current serving cell in a cell DTX active period or a cell DTX/DRX active period and has regarded the cell as a serving cell, and then later, the cell transitions to at least one of the following states is considered.
Cell DTX non-active period and cell DRX active period
Cell DTX non-active period with WUR support

In the disclosure, under the situation, in a case where the UE needs to access a cell, whether the UE is required to transmit a wake-up signal to transition the cell in a cell DTX non-active period to a cell DTX active period and then access the cell through a random access procedure for the cell, the UE is required to perform cell reselection, or the UE is required to wait until the cell enters a cell DTX/DRX active period and then access the serving cell supporting cell DTX/DRX through a random access procedure for the cell is described.

Referring to FIG. 1I, in operation 1i-05, a NES UE 1i-01 may be in an RRC idle mode or an RRC inactive mode.

In an operation 1i-10, the UE in the RRC idle mode or the RRC inactive mode may acquire necessary system information from a NES cell 1i-02 supporting at least cell DTX. The necessary system information may refer to a master information block (MIB) and system information block 1 (SIB1). The necessary system information may include at least one of the following.
An indicator indicating whether the cell supports a cell DTX/DRX function
Whether a cell DTX function and a cell DRX function are supported may be separately indicated.
Cell DTX/DRX pattern information
A periodicity of a cell DTX/DRX active period or cell DTX/DRX non-active period
An offset or one of a slot, subframe, and radio frame indicating a time point at which a cell DTX/DRX active period or cell DTX/DRX non-active period starts
A cell DTX/DRX active period or cell DTX/DRX non-active period on duration
For reference, the cell DTX pattern and cell DRX pattern may be separately provided or only one of the two patterns may be provided.
Frequency/time information required for transmitting a wake-up signal
This may be newly defined or may be defined as a part of resources for existing preamble transmission.
An indicator relating to whether a low-power or wake-up signal receiver is supported

In operation 1i-15, the NES UE 1g-01 in the RRC idle mode or the RRC inactive mode may perform a cell selection procedure to camp on an NR suitable cell supporting at least a cell DTX function. The cell on which the NES UE 1g-01 has camped may be referred to as a serving cell. This may follow the above embodiment.

In operation 1i-35, the NES UE 1i-01 in the RRC idle mode or the RRC inactive mode may acquire system information (e.g., SIB2, SIB3, SIB4, SIB5, or a new SIB) including cell reselection information from the serving cell 1i-02, which is a NES cell supporting at least cell DTX, in order to perform a cell reselection evaluation procedure. This may follow the above embodiment.

In operation 1i-25, the NES UE 1i-01 in the RRC idle mode or the RRC inactive mode may perform a cell reselection evaluation procedure (process). This may follow the above embodiment.

In operation 1i-30, the NES UE 1i-01 may be in anon-active period. That, as a cell DTX non-active period of the serving cell starts, the NES UE 1i-01 may be in a non-active period. In the disclosure, the NES UE 1i-01 may not perform cell reselection until the NES UE needs to access a cell. However, the NES UE 1i-01 may still perform a cell reselection evaluation procedure for cell reselection, but may not perform cell reselection when there is no need to access a cell. Alternatively, the NES UE 1i-01 may not perform cell reselection when the serving cell 1i-02, which is a NES cell supporting at least cell DTX, is in a cell DTX active period and the most recent signal of the serving cell has a value better than a certain threshold value.

In operation 1i-35, the NES UE 1i-01 may need to access a cell. For example, when the NES UE 1i-01 is requested by UE upper layer devices (upper layers) to configure an RRC connection or initiate an RRC connection resume procedure, or when the NES UE is requested by an RRC layer device to initiate an RRC connection resume procedure, the NES UE 1i-01 may need to access a cell.

In operation 1i-40, if the NES UE 1i-01 and the serving cell 1i-02 both support a wake-up signal, the NES UE 1i-01 may transmit a wake-up signal.

In operation 1i-45, the serving cell 1i-02 having received the wake-up signal may transition to a cell DTX active period or end the cell DTX non-active period.

In operation 1i-50, the NES UE 1i-01 may initiate or perform a random access procedure for the cell to configure or resume an RRC connection.

For reference, if operation 1i-40 is not performed or fails, the NES UE 1i-01 may perform at least one of the above embodiments. For example, the following operation 1 or operation 2 may be performed.

### Operation 1)

The NES UE 1i-01 may check whether there is another suitable cell. If possible, the NES UE 1i-01 may select or reselect another suitable cell. Then, the NES UE 1i-01 may initiate a random access procedure for the selected or reselected cell to configure or resume an RRC connection.

If the NES UE 1i-01 determines that there is no suitable cell, the NES UE 1i-01 waits until the current serving cell 1i-02 enters a cell DTX/DRX active period. Then, when the serving cell 1i-02 enters a cell DTX/DRX active period, the NES UE 1i-01 may initiate a random access procedure for the serving cell 1i-02 to configure or resume an RRC connection.

### Operation 2)

If the remaining cell DTX/DRX non-active period of the current serving cell 1i-02 is less than or is less than or equal to a threshold value for a remaining cell DTX/DRX non-active period, the NES UE 1i-01 may wait until the current serving cell is switched to a cell DTX/DRX active period, and then initiate an access procedure for the cell to configure or resume an RRC connection. Otherwise, the NES UE 1i-01 may perform a cell selection or reselection process to initiate an access procedure for the selected or reselected cell to configure or resume an RRC connection.

For reference, the content related to initiating a random access procedure to configure or resume an RRC connection may follow an embodiment described later. It is natural that when the NES UE 1i-01 needs to access a cell while the current serving cell 1i-02 is in a cell DTX active period, the NES UE may transmit a wake-up signal or a preamble to the serving cell 1i-02 or immediately initiate a random access procedure to configure or resume an RRC connection.

FIG. 1J is a diagram illustrating a method of, when a NES cell that is a current serving cell is in a cell DTX/DRX non-active period, accessing a cell by a NES UE according to an embodiment of the disclosure.

In the disclosure, a NES UE in an RRC idle mode (RRC_IDLE) or an RRC inactive mode (RRC_INACTIVE) may have a cell supporting cell DTX/DRX, as a current serving cell. In the disclosure, when the UE has camped on a cell in a cell DTX/DRX active period and has regarded the cell as a serving cell, then later, the cell enters a cell DTX/DRX non-active period, and the UE needs to access a cell, whether the UE is required to perform cell reselection or is required to wait until the cell enters a cell DTX/DRX active period and then access the serving cell supporting cell DTX/DRX through a random access procedure is described.

Referring to FIG. 1J, in operation 1j-05, a NES UE 1j-01 may be in an RRC idle mode or an RRC inactive mode.

In an operation 1j-10, the UE in the RRC idle mode or the RRC inactive mode may acquire necessary system information from a NES cell 1j-02 supporting cell DTX/DRX. The necessary system information may refer to a master information block (MIB) and system information block 1 (SIB1). The necessary system information may include at least one of the following.
An indicator indicating whether the cell supports a cell DTX/DRX function
Cell DTX/DRX pattern information
A periodicity of a cell DTX/DRX active period or cell DTX/DRX non-active period
An offset or one of a slot, subframe, and radio frame indicating a time point at which a cell DTX/DRX active period or cell DTX/DRX non-active period starts
A cell DTX/DRX active period or cell DTX/DRX non-active period on duration
A threshold value for a remaining cell DTX/DRX non-active period
If the remaining cell DTX/DRX non-active period of the current serving cell is less than or is less than or equal to the threshold value, the UE may wait until the current serving cell enters a cell DTX/DRX active period and then access the current serving cell. Otherwise, the UE may select or reselect a cell and access the selected or reselected cell.

In operation 1j-15, the NES UE 1j-01 in the RRC idle mode or the RRC inactive mode may perform a cell selection procedure to camp on an NR suitable cell supporting a cell DTX/DRX function. The cell on which the NES UE 1j-01 has camped may be referred to as a serving cell. This may follow the above embodiment.

In operation 1j-35, the NES UE 1j-01 in the RRC idle mode or the RRC inactive mode may acquire system information (e.g., SIB2, SIB3, SIB4, SIB5, or a new SIB) including cell reselection information from the serving cell 1j-02, which is a NES cell supporting cell DTX/DRX, in order to perform a cell reselection evaluation procedure. This may follow the above embodiment. Additionally, the system information may include the following information.
A threshold value for a remaining cell DTX/DRX non-active period
Information relating to a cell or frequency for which the UE needs to perform access when the cell is in a cell DTX/DRX non-active period.
A frequency-specific cell list
Frequency- or cell-specific random access resource information
A frequency list
Frequency-specific random access resource information

In operation 1j-25, the UE 1j-01 in the RRC idle mode or the RRC inactive mode may perform a cell reselection evaluation procedure (process). This may follow the above embodiment.

In operation 1j-30, the NES UE 1j-01 may be in anon-active period. That, as a cell DTX/DRX non-active period of the serving cell starts, the NES UE 1j-01 may be in a non-active period.

In operation 1j-35, the NES UE 1j-01 may need to access a cell. For example, when the NES UE 1j-01 is requested by UE upper layer devices (upper layers) to configure an RRC connection or initiate an RRC connection resume procedure, or when the NES UE is requested by an RRC layer device to initiate an RRC connection resume procedure, the NES UE 1j-01 may need to access a cell.

In operation 1j-40, the NES UE 1j-01 may perform the following series of procedures.
If information relating to a cell or frequency for which the NES UE 1j-01 needs to perform access is provided, the NES UE 1j-01 may check whether there is a suitable cell on the indicated cell or indicated frequency. If possible, the NES UE 1j-01 may selector reselect the cell. Then, the NES UE may initiate a random access procedure for the selected or reselected cell to configure or resume an RRC connection.
If the NES UE 1j-01 determines that the cell does not exist, the NES UE 1j-01 may wait until the current serving cell 1j-02 enters a cell DTX/DRX active period, and when the serving cell 1j-02 enters the cell DTX/DRX active period, initiate a random access procedure for the serving cell 1j-02 to configure or resume an RRC connection.

Alternatively, in operation 1j-40, the NES UE 1j-01 may perform the following series of procedures.
If the remaining cell DTX/DRX non-active period of the current serving cell 1j-02 is less than or is less than or equal to the threshold value for a remaining cell DTX/DRX non-active period, the NES UE 1j-01 may wait until the current serving cell 1j-02 is switched to a cell DTX/DRX active period, and then initiate an access procedure for the cell to configure or resume an RRC connection. Otherwise, the NES UE 1j-01 may check whether there is a suitable cell on the indicated cell or indicated frequency. If possible, the NES UE 1j-01 may select or reselect the cell. Then, the NES UE may initiate a random access procedure for the selected or reselected cell to configure or resume an RRC connection. If the NES UE 1j-01 determines that the cell does not exist, the NES UE 1j-01 may wait until the current serving cell 1j-02 enters a cell DTX/DRX active period, and when the serving cell 1j-02 enters the cell DTX/DRX active period, initiate a random access procedure for the serving cell to configure or resume an RRC connection.

For reference, the threshold value for a remaining cell DTX/DRX non-active period may be configured by a dedicated RRC message or may be a fixed value internally determined in the UE or specified in a specification. Alternatively, the above information relating to a cell or frequency for which the NES UE 1j-01 needs to perform access may be configured by a dedicated RRC message.

FIG. 1K is a diagram illustrating a method of, when a NES cell that is a current serving cell is in a cell DTX/DRX non-active period, accessing a cell by a NES UE according to an embodiment of the disclosure.

In the disclosure, a NES UE in an RRC idle mode (RRC_IDLE) or an RRC inactive mode (RRC_INACTIVE) may have a cell supporting at least cell DTX, as a current serving cell. In the disclosure, a situation where the UE has camped on the current serving cell in a cell DTX active period or a cell DTX/DRX active period and has regarded the cell as a serving cell, and then later, the cell transitions to at least one of the following states is considered.
Cell DTX non-active period and cell DRX active period
Cell DTX non-active period with WUR support

In the disclosure, under the situation, in a case where the UE needs to access a cell, whether the UE is required to transmit a wake-up signal to transition the cell in a cell DTX non-active period to a cell DTX active period and then access the cell through a random access procedure for the cell, the UE is required to perform cell reselection, or the UE is required to wait until the cell enters a cell DTX/DRX active period and then access the serving cell supporting cell DTX/DRX through a random access procedure for the cell is described.

Referring to FIG. 1K, in operation 1k-05, a NES UE 1k-01 may be in an RRC idle mode or an RRC inactive mode.

In an operation 1k-10, the UE in the RRC idle mode or the RRC inactive mode may acquire necessary system information from a NES cell 1k-02 supporting at least cell DTX. The necessary system information may refer to a master information block (MIB) and system information block 1 (SIB1). The necessary system information may include at least one of the following.
An indicator indicating whether the cell supports a cell DTX/DRX function
Whether a cell DTX function and a cell DRX function are supported may be separately indicated.
Cell DTX/DRX pattern information
A periodicity of a cell DTX/DRX active period or cell DTX/DRX non-active period
An offset or one of a slot, subframe, and radio frame indicating a time point at which a cell DTX/DRX active period or cell DTX/DRX non-active period starts
A cell DTX/DRX active period or cell DTX/DRX non-active period on duration
For reference, the cell DTX pattern and cell DRX pattern may be separately provided or only one of the two patterns may be provided.
Frequency/time information required for transmitting a wake-up signal
This may be newly defined or may be defined as a part of resources for existing preamble transmission.
An indicator relating to whether a low-power or wake-up signal receiver is supported

In operation 1k-15, the UE in the RRC idle mode or the RRC inactive mode may perform a cell selection procedure to camp on an NR suitable cell supporting at least the cell DTX function. The cell on which the UE has camped may be referred to as a serving cell. This may follow the above embodiment.

In operation 1k-35, the UE 1k-01 in the RRC idle mode or the RRC inactive mode may acquire system information (e.g., SIB2, SIB3, SIB4, SIB5, or a new SIB) including cell reselection information from the serving cell 1k-02, which is a NES cell supporting at least cell DTX, in order to perform a cell reselection evaluation procedure. This may follow the above embodiment.

In operation 1k-25, the NES UE 1k-01 in the RRC idle mode or the RRC inactive mode may perform a cell reselection evaluation procedure (process). This may follow the above embodiment.

In operation 1k-30, the NES UE 1k-01 may be in a non-active period. That, as a cell DTX non-active period of the serving cell starts, the NES UE 1k-01 may be in a non-active period. In the disclosure, the NES UE 1k-01 may not perform cell reselection until the NES UE needs to access a cell. However, the NES UE 1k-01 may still perform a cell reselection evaluation procedure for cell reselection, but may not perform cell reselection when there is no need to access a cell. Alternatively, the NES UE 1k-01 may not perform cell reselection when the serving cell 1k-02, which is a NES cell supporting at least cell DTX, is in a cell DTX active period and the most recent signal of the serving cell has a value better than a certain threshold value.

In operation 1k-35, the NES UE 1k-01 may need to access a cell. For example, when the NES UE 1k-01 is requested by UE upper layer devices (upper layers) to configure an RRC connection or initiate an RRC connection resume procedure, or when the NES UE is requested by an RRC layer device to initiate an RRC connection resume procedure, the NES UE 1k-01 may need to access a cell.

In operation 1k-40, if the NES UE 1k-01 and the serving cell 1k-02 both support a wake-up signal, the NES UE 1k-01 may transmit a wake-up signal.

In operation 1k-45, the serving cell 1k-02 having received the wake-up signal may transition to a cell DTX active period or end the cell DTX non-active period.

In operation 1k-50, the NES UE 1k-01 may initiate or perform a random access procedure for the cell to configure or resume an RRC connection.

For reference, if operation 1k-40 is not performed or fails, the NES UE 1k-01 may perform at least one of the above embodiments. For example, the following operation may be performed.

If information relating to a cell or frequency for which the NES UE 1k-01 needs to perform access is provided, the NES UE 1k-01 may check whether there is a suitable cell on the indicated cell or indicated frequency. If possible, the NES UE 1k-01 may select or reselect the cell. Then, the NES UE may initiate a random access procedure for the selected or reselected cell to configure or resume an RRC connection. If the NES UE 1k-01 determines that the cell does not exist, the NES UE 1k-01 may wait until the current serving cell 1k-02 enters a cell DTX/DRX active period, and when the serving cell 1k-02 enters the cell DTX/DRX active period, initiate a random access procedure for the serving cell 1k-02 to configure or resume an RRC connection.

If the information relating to a cell or frequency for which the NES UE 1k-01 needs to perform access is not provided, the NES UE 1k-01 may wait until the current serving cell 1k-02 enters a cell DTX/DRX active period, and when the serving cell 1k-02 enters the cell DTX/DRX active period, initiate a random access procedure for the serving cell 1k-02 to configure or resume an RRC connection.

For reference, the content related to initiating a random access procedure to configure or resume an RRC connection may follow an embodiment described later. It is natural that when the NES UE 1k-01 needs to access a cell while the current serving cell 1k-02 is in a cell DTX active period, the NES UE may transmit a wake-up signal or a preamble to the serving cell 1k-02 or immediately initiate a random access procedure to configure or resume an RRC connection.

FIG. 1L is a diagram illustrating a procedure in which a base station releases a connection of a UE and thus the UE switches from an RRC connected mode to an RRC idle mode and a procedure in which the UE configures a connection with the base station and thus switches from the RRC idle mode to the RRC connected mode according to an embodiment of the disclosure.

Referring to FIG. 1L, in operation 1l-01, if a UE that transmits and receives data in an RRC connected mode does not perform transmission or reception of data due to a predetermined reason or during a predetermined time, a base station may transmit an RRC connection release message (RRCRelease message) to the UE to allow the UE to be switched to an RRC idle mode.

In operation 1l-05, if data to be transmitted occurs in the future, the UE (hereinafter, an idle mode UE) currently having no configured connection performs an RRC connection establishment process with the base station. The UE establishes a reverse transmission synchronization with the base station through a random access process, and transmits an RRC connection request message (RRCSetupRequest message) to the base station. The RRC connection request message may include an identifier of the UE and a cause (establishmentCause) of configuring a connection.

In 1l-10 operation, the base station transmits an RRC connection setup message (RRCSetup message) to allow the UE to configure an RRC connection. The RRC connection setup message includes RRC connection configuration information. An RRC connection is also called a signaling radio bearer (SRB), and is used for transmission and reception of an RRC message that is a control message between the UE and the base station.

In operation 1l-15, the UE having configured the RRC connection transmits an RRC connection setup completion message (RRCSetupComplete message) to the base station. The RRC connection setup completion message includes a service request message used for the UE to request a bearer configuration for a predetermined service from an AMF.

In operation 1l-20, the base station transmits, to the AMF, an initial UE message including the service request message included in the RRC connection setup completion message, and the AMF determines whether to provide the service requested by the UE. If, as a result of the determination, the AMF determines to provide the service requested by the UE, in operation 1l-25, the AMF transmits an initial UE context setup request message to the base station. The initial UE context setup request message includes quality-of-service (QoS) information to be applied at the time of configuration of a data radio bearer (DRB), and security-related information (e.g., a security key or a security algorithm) to be applied to the DRB.

In operation 1l-30 and operation 1l-35, the base station exchanges a security mode command message (SecurityModeCommand message) and a security mode completion message (SecurityModeComplete message) with the UE in order to configure security.

In operation 1l-40, when the security configuration is completed, the base station transmits an RRC connection reconfiguration message (RRCReconfiguration message) to the UE. The RRC connection reconfiguration message includes configuration information of a DRB in which user data is to be processed.

In operation 1l-45, the UE configures the DRB by applying the configuration information of the DRB, and transmits an RRC connection reconfiguration completion message (RRCReconfigurationComplete message) to the base station.

In operation 1l-50, the base station having completed configuration of the DRB with the UE transmits an initial UE context setup request response message to the AMF.

In operation 1l-55, the AMF having received the message performs a session management procedure with a UPF to establish a PDU session.

If the above processes are all completed, in operation 1l-60 and operation 1l-65, the UE transmits and receives data to and from the base station via the UPF. As described above, a general data transmission process generally includes three stages of RRC connection configuration, security configuration, and DRB configuration. In addition, in operation 1l-70, the base station may transmit an RRCReconfiguration message to newly establish, add, or change a configuration for the UE due to a predetermined reason.

As described above, a large amount of signaling procedures is required for a UE to configure an RRC connection and switch from an RRC idle mode to an RRC connected mode. Therefore, in a next-generation mobile communication system, an RRC inactive mode may be newly defined. In the new mode, since the UE and the base station store the context of the UE and may maintain an Si bearer if necessary, when the UE in the RRC inactive mode attempts to re-access a network, the UE may access the network and transmit and receive data more quickly with fewer signaling procedures through an RRC reconnection configuration procedure, which is described below.

FIG. 1M is a diagram illustrating a procedure in which a base station releases a connection of a UE and thus the UE switches from an RRC connected mode to an RRC inactive mode and a procedure in which the UE configures a connection with the base station and thus switches from the RRC inactive mode to the RRC connected mode according to an embodiment of the disclosure.

In FIG. 1M, a UE 1m-01 may perform network connection with a base station 1m-02 and transmit and receive data therewith.

In operation 1m-05, if, for a predetermined reason, the base station 1m-02 needs to transition the UE 1m-01 to an RRC inactive mode, the base station 1m-02 may transmit an RRC connection release message (RRCRelease message) including suspend configuration information (suspendConfig) to transition the UE 1m-01 to the RRC inactive mode.

In operation 1m-10, when the UE 1m-01 having transitioned to the RRC inactive mode needs to perform a RAN notification area update (RNAU), receives 52) RAN paging, or needs to resume an RRC connection with the base station 1m-02, the UE may initiate an RRC connection resume procedure in operation 1m-20.

If a higher layer of the UE 1m-01 requests RRC connection resume or an RRC layer requests RRC connection resume, the UE 1m-01 in the RRC inactive mode performs a random access procedure and transmits an RRC message to the base station 1m-02 in operation 1m-25. In this case, an operation of the UE 1m-01 is as follows.

1) If a useFullResumeID field is signaled in system information (SIB1), the UE 1m-01 may select RRCResumeRequest1 as a message to be transmitted to the base station 1m-02. The UE 1m-01 may prepare for the transmission by including resumeIdentity in an RRCResumeRequest1 message by using a stored full UE connection resume identifier value (fullI-RNTI value). Otherwise, the UE 1m-01 may select RRCResumeRequest as a message to be transmitted to the base station 1m-02. The UE 1m-01 may prepare for the transmission by including shortResumeIdentity in an RRCResumeRequest message by using a stored segmented UE connection resume identifier value (shortI-RNTI value).

2) The UE 1m-01 may select mo-Signalling as a reason (resumeCause) for connection resume.

3) If upper layer devices or a NAS layer provides a PLMN, the UE 1m-01 may configure the PLMN selected by the upper layer devices or the NAS layer as selectedPLMN-Identity from plmn-IdentityList included in SIB1, and include same in an RRCResumeRequest message or an RRCResumeRequest1 message to prepare for the transmission.

4) The UE 1m-01 calculates MAC-I and includes same in a selected message to prepare for the transmission.

5) The UE 1m-01 may recover RRC configuration information (RRC configuration) and security context information from stored UE context, excluding cell group configuration information (cellGroupConfig).

6) The UE 1m-01 updates a new KgNB security key, based on a current KgNB security key, a NextHop (NH) value, and a stored NCC value.

7) The UE 1m-01 derives new security keys (K_RRCenc, K_RRC_int, K_UPint, and K_UPenc) to be used in an integrity protection and verification procedure and an encoding and decoding procedure by using the newly updated KgNB security key.

8) The UE 1m-01 applies updated security keys and a previously configured algorithm for all bearers except SRB0 to resume an integrity protection and verification procedure and applies integrity verification and protection for pieces of data transmitted and received thereafter. This is to enhance the reliability and security of pieces of data transmitted and received via SRB1 or DRBs later.

9) The UE 1m-01 applies updated security keys and a previously configured algorithm for all bearers except SRB0 to resume an encoding and decoding procedure and applies encoding and decoding for pieces of data transmitted and received thereafter. This is to enhance the reliability and security of pieces of data transmitted and received via SRB1 or DRBs later.

10) The UE 1m-01 may recover a PDCP state and re-establish PDCP entities for SRB1.

11) The UE 1m-01 resumes SRB1. This is because the UE is to receive an RRCResume message over SRB1 in response to an RRCResumeRequest message or RRCResumeRequest1 message to be transmitted.

12) The UE 1m-01 configures a message selected for transmission to the base station 1m-02, that is, an RRCResumeRequest message or RRCResumeRequest1 message and transfers the message to lower layer devices.

13) When transmitting the RRCResumeRequest message or the RRCResumeRequest1 message to the base station, the UE 1m-01 operates timer T319.

In operation 1m-25, the UE 1m-01 may performs a random access procedure to perform an RRC connection resume procedure and transmits an RRCResumeRequest message or an RRCResumeRequest1 message to the base station, and then, in operation 1m-30, the UE 1m-01 may receive an RRC connection resume message (RRCResume message) as a response. In this case, an operation of the UE 1m-01 is as follows.

1) The UE 1m-01 stops the timer T319 operated when transmitting the RRCResumeRequest message or the RRCResumeRequest1 message to the base station.

2) If the RRCResume message includes full configuration information (fullConfig), the UE 1m-01 performs a full configuration procedure. Otherwise, when the RRCResume message is received, the UE 1m-01 restores the PDCP state and resets the COUNT values for SRB2 and all DRBs. The UE 1m-01 restores the cell group configuration information (cellGroupConfig) from the stored UE context. Then, the UE 1m-01 indicates the restored information to the lower layer devices.

3) The UE 1m-01 releases the full UE connection resume identifier (FullI-RNTI), the segmented UE connection resume identifier (ShortI-RNTI), and the stored UE context. At this time, RAN notification area information (ran-NotificationAreaInfo) is not released.

4) If the RRCResume message includes master cell group (masterCellGroup) configuration information, the UE 1m-01 may perform a cell group configuration procedure according to the master cell group configuration information.

5) If the RRCResume message includes bearer configuration information (radioBearerConfig), the UE 1m-01 may configure a bearer according to the bearer configuration information.

6) The UE 1m-01 resumes SRB2 and all DRBs

7) If there is stored cell reselection priority information, the UE 1m-01 discards same. The cell reselection priority information may have been stored from CellReselectionPriorities which may be included in an RRCRelease message or may have been inherited from another RAT.

8) If timer T320 is running, the UE 1m-01 may stop same.

9) If the RRCResume message includes frequency measurement configuration information (measConfig), the UE 1m-01 may perform frequency measurement according to the frequency measurement configuration information.

10) If the RRC connection has been suspended, the UE 1m-01 may resume frequency measurement.

11) In operation 1m-35, the UE 1m-01 transitions to an RRC connected mode.

12) The UE 1m-01 informs the upper layer devices that the suspended RRC connection has been resumed.

13) The UE 1m-01 may stop a cell reselection procedure.

14) The UE 1m-01 regards the currently accessed cell as a primary cell (PCell).

15) In operation 1m-40, the UE 1m-01 may configure and transfer an RRC connection resume completion message (RRCResumeComplete message) for transmission to the lower layer devices as follows:

a) If a NAS PDU is provided by the upper layer devices, the UE may include same in a dedicatedNAS-Message.

b) If a PLMN is provided by the upper layer devices or the NAS layer, the UE may configure the PLMN selected by the upper layer devices or the NAS layer as selectedPLMN-Identity from plmn-IdentityList included in SIB1.

FIG. 1N is a block diagram illustrating an internal structure of a UE according to an embodiment of the disclosure.

Referring to FIG. 1N, the UE may include a radio frequency (RF) processor 1n-10, a baseband processor 1n-20, a storage unit 1n-30, and a controller 1n-40.

The RF processor 1n-10 may perform functions for transmitting/receiving signals through a radio channel, such as signal band conversion and amplification. That is, the RF processor 1n-10 may up-convert a baseband signal provided from the baseband processor % n to an RF band signal, may transmit the same through an antenna, and may down-convert an RF band signal received through the antenna to a baseband signal. For example, the RF processor 1n-10 may include a transmission filter, a reception filter, an amplifier, a mixer, an oscillator, a digital-to-analog converter (DAC), an analog-to-digital converter (ADC), and the like. Although only one antenna is illustrated in FIG. 1N, the UE may include multiple antennas. In addition, the RF processor 1n-10 may include multiple RF chains. Furthermore, the RF processor 1n-10 may perform beamforming. For the beamforming, the RF processor 1n-10 may adjust the phase and magnitude of each of signals transmitted and received through multiple antennas or antenna elements. In addition, the RF processor may perform MIMO, and may receive multiple layers when performing a MIMO operation.

The baseband processor 1n-20 may perform functions of conversion between baseband signals and bitstrings according to the system's physical layer specifications. For example, during data transmission, the baseband processor 1n-20 may encode and modulate a transmitted bitstring to generate complex symbols. In addition, during data reception, the baseband processor 1n-20 may demodulate and decode a baseband signal provided from the RF processor 1n-10 to restore a received bitstring. For example, when following the orthogonal frequency division multiplexing (OFDM) scheme, during data transmission, the baseband processor 1n-20 may encode and modulate a transmitted bitstring to generate complex symbols, may map the complex symbols to subcarriers, and may configure OFDM symbols through an inverse fast Fourier transform (IFFT) operation and cyclic prefix (CP) insertion. In addition, during data reception, the baseband processor 1n-20 may split a baseband signal provided from the RF processor 1n-10 at the OFDM symbol level, may restore signals mapped to subcarriers through a fast Fourier transform (FFT) operation, and may restore a received bitstring through demodulation and decoding.

The baseband processor 1n-20 and the RF processor 1n-10 may transmit and receive signals as described above. Therefore, the baseband processor 1n-20 and the RF processor 1n-10 may be referred to as a transmitter, a receiver, a transceiver, or a communication unit. Furthermore, at least one of the baseband processor 1n-20 and the RF processor 1n-10 may include multiple communication modules to support multiple different radio access technologies. In addition, at least one of the baseband processor 1n-20 and the RF processor 1n-10 may include different communication modules to process signals in different frequency bands. For example, the different radio access technologies may include a wireless LAN (e.g., IEEE 802.11), a cellular network (e.g., LTE), and the like. In addition, the different frequency bands may include super high frequency (SHF) (e.g., 2 NRHz) bands and millimeter wave (mmWave) (e.g., 60 GHz) bands.

The storage unit 1n-30 may store basic programs, application programs, and data, such as configuration information, for operation of the main base station. Particularly, the storage unit 1n-30 may store information related to a second access node that performs wireless communication by using a second wireless access technology. In addition, the storage unit 1n-30 provides the stored data at the request of the controller 1n-40.

The controller 1n-40 controls the overall operation of the UE. For example, the controller 1n-40 may transmit/receive signals through the baseband processor 1n-20 and the RF processor 1n-10. In addition, the controller 1n-40 records data in the storage unit 1n-30 and reads the data from the storage unit 1n-30. To this end, the controller 1n-40 may include at least one processor. For example, the controller 1n-20 may include a communication processor (CP) that performs control for communication and an application processor (AP) that controls a upper layer such as an application.

FIG. 1O is a block diagram illustrating a structure of an NR base station according to an embodiment of the disclosure.

As illustrated in FIG. 1O, the base station includes an RF processor 1o-10, a baseband processor 1o-20, a backhaul communication unit 1o-30, a storage unit 1o-40, and a controller 1o-50.

The RF processing unit 1o-10 may perform functions for transmitting/receiving signals through a radio channel, such as signal band conversion and amplification. That is, the RF processor 1o-10 may up-convert a baseband signal provided from the baseband processor 1o-20 to an RF band signal, may transmit the same through an antenna, and may down-convert an RF band signal received through the antenna to a baseband signal. For example, the RF processor 1o-10 may include a transmission filter, a reception filter, an amplifier, a mixer, an oscillator, a DAC, and an ADC. Although only one antenna is illustrated in the drawing, the first access node may include multiple antennas. In addition, the RF processor 1o-10 may include multiple RF chains. Furthermore, the RF processor 1o-10 may perform beamforming. For the beamforming, the RF processor 1o-10 may adjust the phase and magnitude of each of signals transmitted and received through multiple antennas or antenna elements. The RF processor may transmit one or more layers to perform a downward MIMO operation.

The baseband processor 1o-20 may perform functions of conversion between baseband signals and bitstrings according to the physical layer specifications of first radio access technology. For example, during data transmission, the baseband processor 1o-20 may encode and modulate a transmitted bitstring to generate complex symbols. In addition, during data reception, the baseband processor 1o-20 may demodulate and decode a baseband signal provided from the RF processor 1o-10 to restore a received bitstring. For example, when following the OFDM scheme, during data transmission, the baseband processor 1o-20 may encode and modulate a transmitted bitstring to generate complex symbols, may map the complex symbols to subcarriers, and may configure OFDM symbols through IFFT operation and CP insertion. In addition, during data reception, the baseband processor 1o-20 may split a baseband signal provided from the RF processor 1o-10 at the OFDM symbol level, may restore signals mapped to subcarriers through FFT operation, and may restore a received bitstring through demodulation and decoding. The baseband processor 1o-20 and the RF processor 1o-10 may transmit and receive signals as described above. Therefore, the baseband processor 1o-20 and the RF processor 1o-10 may be referred to as a transmitter, a receiver, a transceiver, a communication unit, or a wireless communication unit.

The backhaul communication unit 1o-30 may provide an interface for communicating with other nodes in the network. That is, the backhaul communication unit 1o-30 may convert bitstrings transmitted from the main base station to other nodes (for example, auxiliary base station, core network) to physical signals, and may convert physical signals received from the other nodes to bitstrings.

The storage unit 1o-40 may store basic programs, application programs, and data, such as configuration information, for operation of the main base station. Particularly, the storage unit 1o-40 may store information regarding a bearer allocated to a connected UE, a measurement result reported from the connected UE, and the like. In addition, the storage 1o-40 may store information serving as a criterion for determining whether to provide or stop multiple connections to the UE. In addition, the storage unit 1o-40 provides the stored data at the request of the controller 1o-40.

The controller 1o-50 controls the overall operation of the main base station. For example, the controller 1o-50 may transmit/receive signals through the baseband processor 1o-20 and the RF processor 1o-10 or through the backhaul communication unit 1o-30. In addition, the controller 1o-50 records data in the storage unit 1o-40 and reads the data from the storage 1o-40. To this end, the controller 1o-50 may include at least one processor.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the drawings in which methods of the disclosure are described, the order of the description does not always correspond to the order in which steps are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Also, the above respective embodiments may be employed in combination, as necessary.

1. A method of a terminal in a wireless communication system, the method comprising:
entering an RRC idle state or an RRC inactive state;
camping on a cell;
receiving system information for cell reselection from the cell; and
performing cell reselection in a cell non-active period of the cell.

2. The method of claim 1, wherein the performing of cell reselection in the cell non-active period of the cell comprises:
in case that it is determined that there is a suitable cell, based on the system information, performing cell reselection for the suitable cell; and
in case that it is determined that there is no suitable cell, based on the system information, performing cell reselection in a cell active period after termination of the cell non-active period.

3. The method of claim 2, wherein the system information comprises information related to cell reselection of the terminal,
wherein the information related to cell reselection of the terminal comprises a frequency-specific cell list including frequency- or cell-specific random access resource information or frequency-specific random access resource information, and
wherein the performing of cell reselection in the cell non-active period of the cell comprises performing cell reselection, based on the information related to cell reselection.

4. The method of claim 1, wherein the system information comprises a threshold value related to the cell non-active period, and
wherein the performing of cell reselection in the cell non-active period of the cell comprises:
in case that a remaining time of the cell non-active period is equal to or smaller than the threshold value, performing cell reselection in a cell active period after termination of the cell non-active period; and
in case that the remaining time of the cell non-active period is greater than the threshold value, immediately performing cell reselection.

5. The method of claim 1, wherein the performing of cell reselection in the cell non-active period of the cell comprises:
transmitting a wake-up signal to the cell; and
in case that the cell transitions to a cell active period due to the wake-up signal, performing cell reselection for the cell.

6. The method of claim 5, wherein the system information comprises:
at least one of frequency information and time information related to the wake-up signal; and
an indicator indicating whether at least one of a low-power receiver and a wake-up signal receiver is supported.

7. The method of claim 5, wherein the performing of cell reselection in the cell non-active period of the cell comprises:
in case that it is determined that there is a suitable cell, based on a frequency and a cell related to cell reselection, performing cell reselection for the suitable cell; and
in case that it is determined that there is no suitable cell, performing cell reselection in the cell active period after termination of the cell non-active period.

8. The method of claim 1, wherein the system information comprises at least one of an indicator indicating whether at least one of cell DTX and cell DRX is supported, and cell DTX pattern information and cell DRX pattern information.

9. A terminal in a wireless communication system, the terminal comprising:
a transceiver; and
a controller connected to the transceiver,
wherein the controller is configured to:
enter an RRC idle state or an RRC inactive state;
camp on a cell;
receive system information for cell reselection from the cell; and
perform cell reselection in a cell non-active period of the cell.

10. The terminal of claim 9, wherein the controller is configured to:
in case that it is determined that there is a suitable cell, based on the system information, perform cell reselection for the suitable cell; and
in case that it is determined that there is no suitable cell, based on the system information, perform cell reselection in a cell active period after termination of the cell non-active period.

11. The terminal of claim 10, wherein the system information comprises information related to cell reselection of the terminal,
wherein the information related to cell reselection of the terminal comprises a frequency-specific cell list including frequency- or cell-specific random access resource information or frequency-specific random access resource information, and
wherein the controller is configured to perform cell reselection, based on the information related to cell reselection.

12. The terminal of claim 9, wherein the system information comprises a threshold value related to the cell non-active period, and
wherein the controller is configured to:
in case that a remaining time of the cell non-active period is equal to or smaller than the threshold value, perform cell reselection in a cell active period after termination of the cell non-active period; and
in case that the remaining time of the cell non-active period is greater than the threshold value, immediately perform cell reselection.

13. The terminal of claim 9, wherein the controller is configured to:
transmit a wake-up signal to the cell; and
in case that the cell transitions to a cell active period due to the wake-up signal, perform cell reselection for the cell.

14. The method of claim 13, wherein the system information comprises:
at least one of frequency information and time information related to the wake-up signal; and
an indicator indicating whether at least one of a low-power receiver and a wake-up signal receiver is supported.

15. The terminal of claim 13, wherein the controller is configured to:
in case that it is determined that there is a suitable cell, based on a frequency and a cell related to cell reselection, perform cell reselection for the suitable cell; and
in case that it is determined that there is no suitable cell, perform cell reselection in the cell active period after termination of the cell non-active period.
